(19) United States
(12) Patent Application Publication
(10) Pub. No.: US 2020/0389714 A1
(43) Pub. Date: Dec. 10, 2020

(54) DUAL-MODE AUDIO SYSTEM

(71) Applicant: Human, Incorporated, Seattle, WA (US)

(72) Inventors: Nicholas Roche, Edinburgh (GB); Michael Sapene, Rennes (FR); Eliza Arango-Vargas, Redmond, WA (US); Benjamin S. Willis, Bellevue, WA (US)

(21) Appl. No.: 16/894,436

(22) Filed: Jun. 5, 2020

Related U.S. Application Data
(60) Provisional application No. 62/858,035, filed on Jun. 6, 2019.

(51) Int. Cl. H04R 1/02

(52) U.S. Cl. CPC H04R 1/02

(57) ABSTRACT

Various embodiments provide for an audio system and methods for facilitating a group-listening user experience. A first audio device and a second audio device may each include at least one speaker. The first audio device and the second audio device may be selectively coupled to each other via one or more coupling devices. In such embodiments, the respective speaker or speakers of each of the first and second audio devices may be configured to direct sound into the combined acoustic chamber formed by the first and second audio devices. The combined acoustic chamber may be configured to have a shape that is suitable for mixing, combining, blending, acoustically amplifying, and/or directing the sound from the speakers of the first and second audio devices in a direction that is away from the audio system.

### CROSS REFERENCE TO RELATED APPLICATION

This application claims the benefit of U.S. Provisional Patent Application No. 62/858,035, filed on Jun. 6, 2019, which application is incorporated herein by reference in its entirety.

### BACKGROUND

Some audio systems—such as headphones—include speaker elements that are worn close to users' ears. As a result, these speaker elements may output audio at a comparatively low volume that may enable users wearing such audio systems to enjoy media without disturbing others close by. For users that desire to listen to audio with one or more other users, some audio systems include speaker elements that are configured to output audio at a volume that may be heard by a group of nearby users (e.g., in the same room). However, current audio systems typically are not configured to operate selectively as both a personal-listening system (e.g., headphones) and as a group-listening system (e.g., a public-address system). As a result, a user may need to utilize one audio system for personal listening and a second, separate audio system for group listening.

### BRIEF DESCRIPTION OF THE DRAWINGS

The foregoing embodiments and many of the attendant advantages will become more readily appreciated as the same become better understood by reference to the following detailed description, when taken in conjunction with the accompanying drawings, wherein:

FIG. 1 is a communication system diagram illustrating an audio system, according to some embodiments.

FIG. 2 is a component block diagram illustrating an audio device included in the audio system illustrated in FIG. 1, according to some embodiments.

FIGS. 3A-3E are exterior views of an audio device illustrated in FIGS. 1-2, according to some embodiments.

FIG. 4 is an exterior view of an audio device secured to a user's ear, according to some embodiments.

FIGS. 5A-5B are exterior views of the audio device depicted in FIGS. 1-4, according to some embodiments.

FIG. 6 is an exterior view of an example operational environment of the audio device depicted in FIGS. 1-5B, according to some embodiments.

FIG. 7 is a component block diagram illustrating a first audio device and a second audio device, according to some embodiments.

FIGS. 8A-8E are exterior views of an audio system, according to some embodiments.

FIGS. 9A-9B are exterior views of an example operational environment of the audio system depicted in FIGS. 8A-8E, according to some embodiments.

FIG. 10 is a process flow diagram illustrating an embodiment method for configuring an audio device in an audio system to operate in a group-listening mode or a personal-listening mode, according to some embodiments.

FIG. 11 is a schematic diagram of electronic filter circuitry, according to one embodiment.

### DETAILED DESCRIPTION

Various embodiments of the attachment apparatus may be described with reference to certain anatomical features of a human user's ear. For ease of reference, the anatomical features of a user's ear may be referred to in this disclosure using the following terms. The term “root of an ear” refers to a portion of the ear that is proximal to the user's head. Specifically, the root of a user's ear may be a portion or structure of the ear that secures the ear to the user's head. Also, as used herein, the term “outer ear” refers to the portion of the ear that is distal to the user's head as compared to the root of the ear. The outer ear may include or otherwise be defined by at least a portion of the ear's auricle, helix, and/or lobule. Typically, the perimeter of the outer ear of an ear is greater than the perimeter of the root of the ear. The term “upper root portion of the ear” generally refers to a portion of the root of the ear that is proximal to the top of the user's head. In contrast, the term “lower root portion of the ear” refers to a portion of the root of the ear that is distal to the top of the user's head. Further, the terms “front of an ear” and “anterior portion of an ear” are used interchangeably and refer to a portion of the ear that is proximal to a user's face and distal to the back of the user's head. The front of the ear may include portions of the helix, the antihelix, tragus, and antitragus that are proximal to the user's face. The term “anterior root portion of the ear” generally refers to a portion of the root of the ear corresponding to the anterior portion of the ear. The terms “back of an ear” and “posterior portion of an ear” are used interchangeably and refer to a portion of the ear that is proximal to the back of the user's head and distal to the user's face. The back of the ear may include portions of the helix and the antihelix proximal to the back of the user's head. Similarly, the term “posterior root portion of the ear” generally refers to a portion of the root of the ear corresponding to the posterior portion of the ear. The term “interior portion of an ear” refers to a portion of the outer ear proximal to, but not including, the ear canal. The interior portion of an ear may include, without limitation, at least part of one or more of the concha, anti-helix, anti-tragus, and tragus. Further descriptions and references to the foregoing terms are provided herein.

As used herein, the terms “speaker” or “loud speaker” are used interchangeably and generally refers to an electroacoustic transducer that is configured to convert an electrical signal into audible sound. The term “personal-listening speaker” refers to a speaker that is configured to play out audio at a volume that is suitable for use as a personal listening device. By way of a non-limiting example, a personal-listening speaker may be included in headphone or earphone devices configured to output audio close to a user's ear without damaging the user's hearing. The term “group-listening speaker” refers to a speaker that is configured to output audio at a volume that is suitable for use as a group-listening device. In a non-limiting example, a group-listening speaker may be included in a portable loud speaker, such as a portable Bluetooth® speaker, and may be configured to play out audio having a volume that is audible to a group of individuals close to the group-listening speaker. As used herein, the term “back volume” generally refers to a volume of air on a rearward-facing side of a speaker driver, and the term “front volume” generally refers to another volume of air on a frontward-facing side of a speaker driver, as would be known by one of ordinary skill in the art.

As used herein, the term “full-range speaker” refers to a speaker that is configured to generate sound frequencies at least substantially within the human-hearing range (˜20 Hz to 20,000 Hz). The term “low-range speaker” refers herein to a speaker that is configured to generate sound frequencies primarily (or exclusively) in a range that is at least substantially lower than a mid-to-high-range speaker. By way of a non-limiting example, the frequency range of a low-range speaker may be from 20 Hz to 2,000 Hz. In another non-limiting example, the low-range speaker may be configured as a woofer, mid-woofer, or subwoofer, as would be known by one skilled in the art. The term “high-range speaker” refers herein to a speaker that is configured to generate sound frequencies primarily (or exclusively) in a range that is at least substantially higher than the range of frequencies produced by a low-range speaker. By way of a non-limiting example, a high-range speaker may produce frequencies between 2,000 Hz and 20,000 Hz. In another non-limiting example, a high-range speaker may be configured as a tweeter, as would be known by one skilled in the art.

In overview, aspects of the present disclosure include audio systems that feature improvements over current audio systems, such as those described above. In some embodiments, an audio system may include a first audio device that includes a first speaker and a second speaker. The first speaker may be selectively configurable to operate as either a full-range, personal-listening speaker or a low-range, group-listening speaker. The second speaker may be configured to be inactive (or in a lower power state) while the first speaker is configured as a full-range, personal-listening speaker or to be configured as a high-range, group-listening speaker while the first speaker is configured to operate as a low-range, group-listening speaker. In some embodiments, the first audio device may be secured to a user's ear so that the first speaker is positioned near the user's ear. While secured on the user's ear, the first audio device may be configured to operate in a personal-listening mode whereby the first speaker is configured to operate as a full-range, personal-listening speaker. Specifically, because the first speaker is positioned near the user's ear, the first speaker may be configured to output sound in a wide range of frequencies and at a relatively low volume so that the user may comfortably enjoy a full-range of sound coming from the first speaker. While the first audio device is configured in a personal-listening mode, the second speaker may not be used and, in some embodiments, may be caused to operate in a low power state.

In some embodiments, the first audio device may be configured to operate in a group-listening mode in which the first and second speakers of the audio device are configured to operate as group-listening speakers. The first audio device may not be secured to the user's ear (as to avoid damaging the user's hearing). In some embodiments in which the first audio device is configured to operate in a group-listening mode, the first speaker may be configured to operate as a low-range, group-listening device. Specifically, the first speaker may be configured to generate sounds having frequencies in a lower portion of the range of human hearing (e.g., without limitation, frequencies between 20 Hz and 2000 Hz). The first speaker may be configured to generate these sounds at a volume that may be experienced by users within the immediate area of the first audio device. The second speaker may be configured to generate sounds having frequencies in a higher portion of the range of human hearing (e.g., without limitation, frequencies between 2000 Hz and 20,000 Hz). The second speaker may be configured to generate these sounds at a volume that may also be experienced by users within the immediate area of the first audio device.

In some embodiments, the first audio device may be powered by a battery. Accordingly, to achieve an increase in power usage efficiency, the first speaker may have one or more characteristics that may enable the first speaker to generate low-range frequencies more efficiently than the second speaker. By way of a non-limiting example, the first speaker may be larger than the second speaker so that the first speaker may generate lower frequencies using less energy than the second speaker. The second speaker may be configured to have one or more characteristics that enable the second speaker to generate high-range frequencies more efficiently than the first speaker. In a non-limiting example, the second speaker may be a micro-speaker with a form factor than is smaller than the first speaker. Due to the second speaker's smaller form factor, the second speaker may generate high-range frequencies using less power than the power required for the first speaker to generate the same high-range frequencies. Further, in some embodiments in which the audio device is portable, the combination of the smaller form factor of the second speaker and the larger form factor of the first speaker may enable the audio device to produce a high-quality sound using comparatively less power while keeping the overall weight of the first audio device down.

In some embodiments in which the first audio device is configured to operate in a group-listening mode, a speaker control service running on one or more processors included on the first audio device (e.g., one or more CPUs or DSPs) may coordinate and synchronize output of sound via the first and second speakers. For example, the speaker control service may cause an audio signal representing sound to be split between the first and second speakers, respectively. In such an example, low-range frequencies may be directed to the first speaker, and high-range frequencies may be directed to the second speaker. Accordingly, output of the audio signal as sound via the first and second speakers may be synchronized so that the full-range of frequencies represented in the audio signal are included in the combined sound generated from the first and second speakers.

In some embodiments, the first audio device may be configured to form an acoustic chamber when the first audio device is secured to a user's ear or when the first audio device is placed against a surface (e.g., a table top). In such embodiments, the first speaker may output sound into the acoustic chamber both when the first audio device is configured to operate in a personal-listening mode or in a group-listening mode. The acoustic chamber may function as a front volume for the first speaker, enabling the first speaker to use the air in the acoustic chamber to generate sound relatively efficiently. When the first audio device is secured to the user and operating in a personal-listening mode, full-range sound generated from the first speaker is directed to the user's ear. However, when the first audio device is operating in a group-listening mode, sound generated from the first and second speaker may be directed outward so that one or more nearby users can hear the sound without placing the first audio device near their ear.

In some embodiments in which the first audio device is placed on a surface, the first audio device may be configured to form an acoustic opening along a portion of the first audio device. In such embodiments, while the first audio device is configured to operate in a group-listening mode, low-range sounds generated by the first speaker may be directed from the acoustic chamber through the acoustic opening into ambient air, and the acoustic chamber and acoustic opening may thereby function essentially as a front volume and an acoustic horn that collectively improve impedance matching, bass response, and power consumption while also effectively directing sound away from the first audio device into the ambient air. In some additional (or alternative) embodiments, the acoustic chamber and acoustic opening may function as a Helmholtz resonator, thereby enabling the first speaker to generate low-frequency sounds effectively and with less power. At the same time the first speaker is generating low-frequency sounds, the second speaker may be configured to generate synchronized, high-frequency sound that is directed away from the first audio device.

In some embodiments, an audio system may include the first audio device and a second audio device. The second audio device may be configured as a mirror image of the first audio device. The second audio device may include, inter alia, a third speaker configured as a mirror image of the first speaker of the first audio device and may include a fourth speaker configured as a mirror image of the second speaker of the first audio device. The second audio device may be selectively configured to operate in a personal-listening mode or a group-listening mode as generally described with reference to the first audio device. In some embodiments, the first and second audio device may be collectively configured to operate in a personal-listening mode or a group-listening mode at the same time. In some embodiments, the first and second device may be configured to output sound in concert in either a personal-listening mode using the first and third speakers or a group-listening mode using the first, second, third, and fourth speakers. In some embodiments, the first audio device and the second audio device may output different portions (e.g., channels) of an audio stream. For example, the first audio device may output sound represented in a left channel of an audio stream, and the second audio device may output sound represented in a right channel of the same audio stream. In various embodiments, the first, second, third, and fourth speakers may be coordinated to play out audio in concert (e.g., synchronized).

As described, the first audio device may be configured to form an acoustic chamber near the first speaker when secured to a user or when coupled to a surface. As the second audio device may be configured as a mirror image of the first audio device in some embodiments, the second audio device may also be configured to form an acoustic chamber near the third speaker. In some embodiments, the first audio device and the second audio device may be configured so that they are selectively coupled to each other via one or more coupling devices (e.g., interlocking components, magnets, or the like). While coupled together, the acoustic chamber formed by the first audio device and the acoustic chamber formed by the second audio device may collectively form/define a combined acoustic chamber. In this configuration, each of the first audio device and the second audio device may collectively utilize the combined acoustic chamber to generate sound suitable for group listening. While the first audio device and the second audio device are decoupled, the combined acoustic chamber may be unformed, and the first audio device and the second audio device may be individually configured to generate sound suitable for personal listening (or group-listening) as described above.

In some embodiments, when the first audio device is coupled to the second audio device, the first and second audio devices may be collectively configured to form an acoustic opening that enables sound to exit from the acoustic chamber. In some embodiments, the acoustic opening may direct low-range frequency sounds down towards a surface on which the first and second audio devices are resting, which may reflect off the surface into the ambient air. In some embodiments, vibrations generated by the first and third speakers may pass through the first and second audio devices into the surface on which the first and second audio devices are resting, thereby causing the surface to act as a resonator and increasing the perceived volume of the sound generated by the first and third speakers.

In some embodiments, the first speaker of the first audio device and the third speaker of the second audio device may collectively utilize the combined acoustic chamber as a front volume in order to generate sound suitable for group listening. In such embodiments, the frontward side of the first speaker of the first audio device may be configured to face the combined acoustic chamber and to direct sound into the combined acoustic chamber. Similarly, the frontward side of the third speaker of the second audio device may also be configured to face the combined acoustic chamber and to direct sound into the combined acoustic chamber at or about the same time as the first speaker of the first audio device directs sound into the combined acoustic chamber. The combined acoustic chamber may have a shape that is suitable for mixing, combining, blending, concentrating, acoustically/passively amplifying, and/or directing the sound output from the first audio device and/or the second audio device. In some embodiments, the first speaker may generate sound within the combined acoustic chamber that is in phase with sound generated by the third speaker. The combined acoustic chamber may enable this in-phase sound to create high sound pressure levels and improved frequency extension down to bass frequencies without requiring additional power consumption by the first and second audio devices. Thus, by coupling together the first and second audio devices, the perceived volume of sound produced from the speakers of the first and second audio device may be increased and/or the characteristics of the sound may be modified, such as by improving the bass response of such sound. According to such embodiments, coupling the first and second audio devices together may enable or improve the ability of the audio system to function as a group-listening device.

In some embodiments, one or more speakers included in the first audio device may be configured to operate as personal-listening speakers while the first audio device is not coupled to the second audio device (or, in some embodiments, while also not coupled to a base device). For example, while the first audio device is not coupled to the second audio device, the second speaker included in the first audio device may be deactivated or disabled and the first speaker included in the first audio device may be activated or enabled and configured to operate as a personal-listening speaker. Upon coupling the first audio device to the second audio device (or to the base device or other surface), one or more of the speakers included in the first audio device may be configured to operate as group-listening speakers. In a non-limiting example, in response to coupling the first audio device to the second audio device (or to the base device or other surface), the second speaker included in the first audio device may be activated or enabled and the first speaker included in the first audio device may be configured to operate as a group-listening speaker. In some embodiments, coupling or decoupling the first audio device from the second audio device or the base device may cause one or more speakers included in the first audio device to transition from operating as group-listening speakers to personal-listening speakers, or vice versa. Accordingly, in such embodiments, the first speaker included in the first audio device may selectively function as either a group-listening speaker or a personal-listening speaker. The second audio device may be configured similarly to the first audio device (e.g., configured as a mirror-image of the first audio device) and thus may include one or more speakers configured to operate as personal-listening speakers while the second audio device is not coupled to the first audio device (or to the base device) and configured to operate as group-listening speakers while coupled to the first audio device (or to the base device).

Various embodiments will be described in detail with reference to the accompanying drawings. Wherever possible, the same reference numbers will be used throughout the drawings to refer to the same or like parts. References made to examples and implementations are for illustrative purposes and are not intended to limit the scope of the invention or the claims.

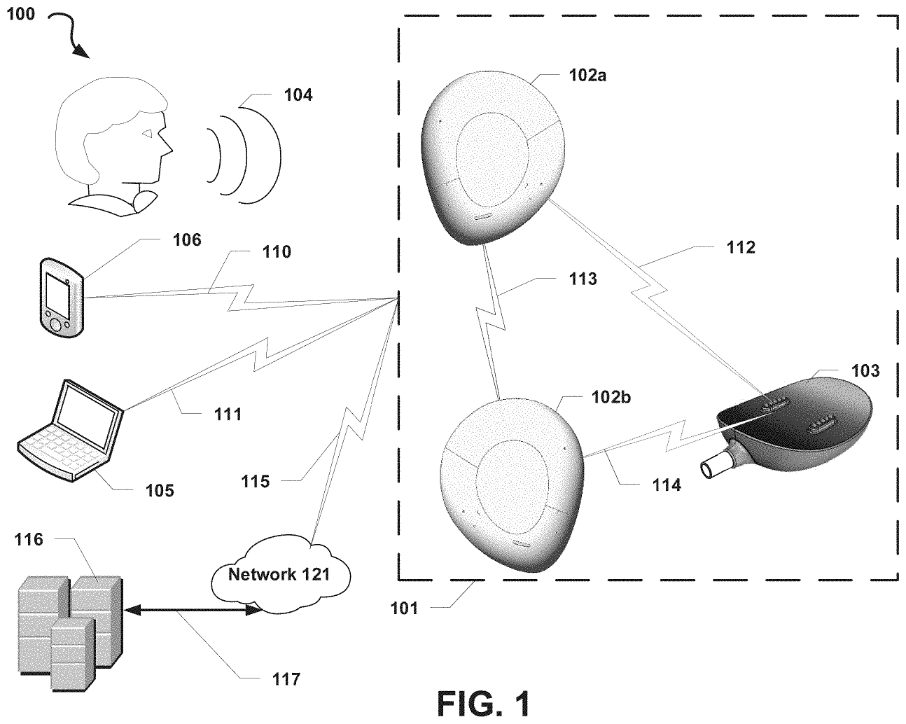

FIG. 1 is a functional block diagram of an illustrative operating environment 100 that includes an audio system 101 suitable for implementing aspects of the present disclosure, according to some embodiments. In the example illustrated in FIG. 1, the audio system 101 may include a first audio device 102a and a second audio device 102b. In some optional embodiments, the audio system 101 may also include a base device 103 configured to couple to or otherwise operate in conjunction with one or both of the first audio device 102a and the second audio device 102b.

The first audio device 102a and the second audio device 102b may communicate with each other via a wireless communication link 113, such as a Wi-Fi Direct, Bluetooth®, near-field magnetic, induction or similar communication link. In some embodiments, the first audio device 102a and the second audio device 102b may maintain a master-slave relationship in which one of the first audio device 102a or the second audio device 102b (the “master” device) coordinates activities, operations, and/or functions between the devices 102a, 102b via the wireless communication link 113. The other of the first audio device 102a or the second audio device 102b (the “slave” device) may receive commands from and may provide information or confirmations to the master device via the communication link 113. By way of a non-limiting example, the first audio device 102a may be the master device and may provide audio data and timing/synchronization information to the second audio device 102b to enable the second audio device 102b to begin output of the audio data in sync with output of the audio data by the first audio device 102a. In this example, the first audio device 102a may provide a data representation of a song and timing information to the second audio device 102b to enable the second audio device 102a and the first audio device 102a to play the song at the same time via one or more of their respective speakers. Alternatively, the first audio device 102a and the second audio device 102b may be peer devices in which each of the devices 102a, 102b shares information, sensor readings, data, and the like and coordinates activities, operations, functions, or the like between the devices 102a, 102b without one device directly controlling the operations of the other device.

The first audio device 102a and/or the second audio device 102b may be in communication with the base device 103, for example, via wired or wireless communication links (e.g., wireless links 112, 114). In some embodiments, the base device 103 may provide information or other data (e.g., audio data) to each of the first audio device 102a and the second audio device 102b. By way of a non-limiting example, the base device 103 may provide audio data and/or timing data to the first audio device 102a and the second audio device 102b to enable the devices 102a, 102b to play out the audio data at the same or nearly the same time. In some embodiments, the base device 103 may be in communication with only one of the first audio device 102a and the second audio device 102b (e.g., the “master” device, as described), and information or data provided from the base device 103 to the master device may be shared with the other one of the first audio device 102a and the second audio device 102b (e.g., the “slave” device, as described).

In some embodiments, at least one device of the audio system 101 (e.g., one of the first audio device 102a, the second audio device 102b, or the base device 103) may be in communication with one or more computing devices outside of the audio system 101 and may send and receive information and other data to and from these computing devices. In the non-limiting example illustrated in FIG. 1, at least one device of the audio system 101 may be in communication with a mobile computing device 106 via a wireless communication link 110 and/or another computing device 105 via a wireless communication link 111. For example, the first audio device 102a and the second audio device 102b may each establish a Bluetooth® communication link with the mobile computing device 106 (e.g., a smartphone) and may stream audio from the mobile computing device 106. Those skilled in the art will recognize that the computing devices 105 and 106 may be any of a number of computing devices capable of communicating via a wireless or wired link including, but not limited to, a laptop, personal computer, personal digital assistant (PDA), hybrid PDA/mobile phone, mobile phone, smartphone, wearable computing device (e.g., wireless headphones or earphones), electronic book reader, digital media player, tablet computer, gaming console or controller, kiosk, augmented or virtual reality device, other wireless device, set-top or other television box, or the like.

Additionally (or alternatively), at least one device of the audio system 101 may be in direct or indirect communication with one or more servers 116 via at least one network 121. For example, at least one of the devices in the audio system 101 may establish a wireless communication link 115 (e.g., a Wi-Fi link, a cellular LTE link, or the like) to a wireless access point, a cellular base station, and/or another intermediary device that may be directly or indirectly in communication with the one or more servers 116. In such embodiments, at least one of the devices in the audio system 101 may communicate indirectly with the one or more servers 116 via one or more intermediary devices. In another example, the first audio device 102a and/or the second audio device 102b may send, via the network 121, a request for a stream of audio data from the one or more servers 116, and the one or more servers 116 may respond to the request by providing the first audio device 102a and/or the second audio device 102b with the requested stream of data via a communication link 117 with the network 121. In some embodiments, at least one device of the audio system 101 may include a microphone configured to receive an analog source of sound 104 (e.g., a human).

Each of the communication links 110, 111, 112, 113, 114, 115, 117 described herein may be communication paths through networks (not shown), which may include wired networks, wireless networks or combination thereof (e.g., the network 121). In addition, such networks may be personal area networks, local area networks, wide area networks, cable networks, satellite networks, cellular telephone networks, etc. or combination thereof. In addition, the networks may be a personal area network, local area network, wide area network, over-the-air broadcast network (e.g., for radio or television), cable network, satellite network, cellular telephone network, or combination thereof. In some embodiments, the networks may be private or semi-private networks, such as a corporate or university intranets. The networks may also include one or more wireless networks, such as a Global System for Mobile Communications (GSM) network, a Code Division Multiple Access (CDMA) network, a Long Term Evolution (LTE) network, or some other type of wireless network. Protocols and components for communicating via the Internet or any of the other aforementioned types of communication networks are well known to those skilled in the art and, thus, are not described in more detail herein.

For ease of description, the audio system 101 is illustrated in FIG. 1 as being in communication with the devices 105, 106 and the one or more servers 116. However, in some embodiments, the audio system 101 may be in communication with more or fewer communication computing devices and/or servers than those illustrated in FIG. 1.

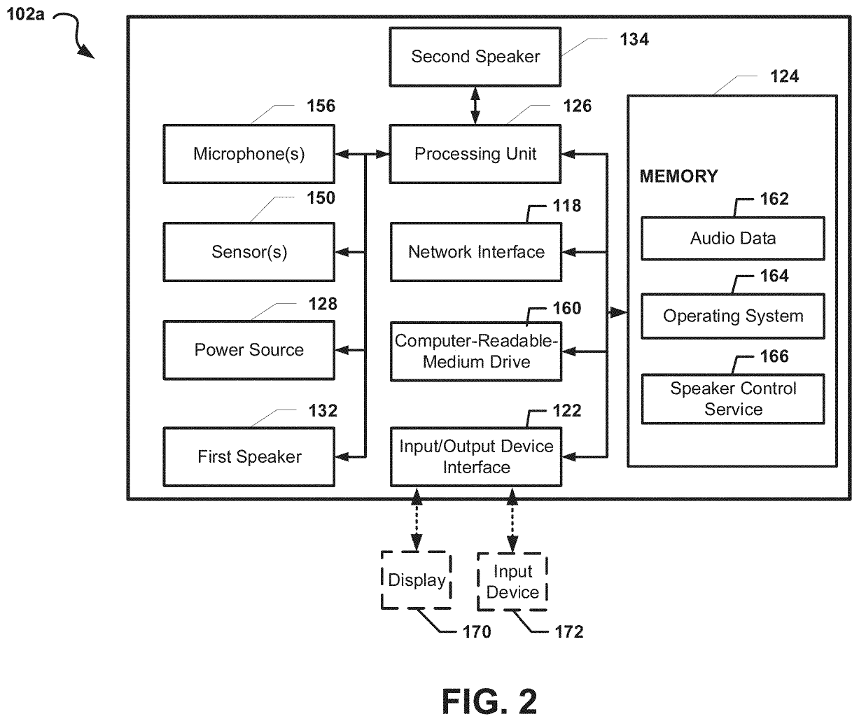

FIG. 2 depicts a general architecture of the first audio computing device 102a, which includes an arrangement of computer hardware and software components that may be used to implement aspects of the present disclosure, according to some embodiments. The first audio computing device 102a may include many more (or fewer) elements than those shown in FIG. 2. It is not necessary, however, that all of these generally conventional elements be shown in order to provide an enabling disclosure.

As illustrated, the first audio device 102a may include (or be coupled to) an input/output device interface 122, a network interface 118, least one optional microphone 156, a memory 124, a processing unit 126, a power source 128, an optional display 170, a first speaker 132, a second speaker 134, a computer-readable-medium drive 160, all of which may communicate with one another by way of a communication bus. The network interface 118 may provide connectivity to one or more networks or computing systems, and the processing unit 126 may receive and/or send information and instructions from/to other computing systems or services via the network interface 118. For example (as illustrated in FIG. 1), the network interface 118 may be configured to communicate with the second audio device 102b, the base device 103, the mobile computing device 106, and/or the other computing device 105 via wireless communication links, such as via a Wi-Fi Direct or Bluetooth communication links. The network interface 118 may also (or alternatively) be configured to communicate with one or more computing devices via a wired communication link (not shown). In some embodiments, the network interface 118 may receive audio data from one or more other computing devices and may provide the audio data to the processing unit 126. In such embodiments, the processing unit 126 may cause the audio data to be transformed into an electrical audio signal that is provided to the at least one speaker 132, 134 for output as sound.

The processing unit 126 may communicate to and from memory 124 and may provide output information for an optional display 170 via the input/output device interface 122. In some embodiments, the memory 124 may include RAM, ROM, and/or other persistent, auxiliary or non-transitory computer-readable media. The memory 124 may store an operating system 164 that provides computer program instructions for use by the processing unit 126 in the general administration and operation of the first audio device 102a. In some embodiments, the memory 124 may contain digital representations of audio data 162 or electronic audio signals (e.g., digital copies of songs or videos with audio). In such embodiments, the processing unit 126 may obtain the audio data 162 or electronic audio signals from the memory 124 and may provide electronic audio signals to the first speaker 132 and/or the second speaker 134 for playout as sound.

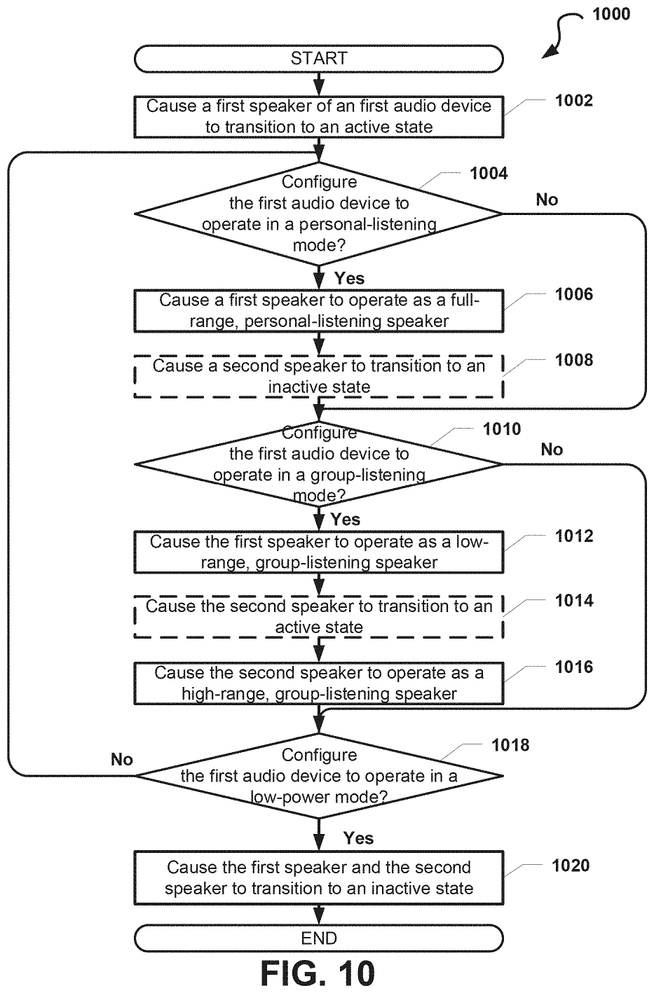

In some embodiments, the memory 124 may further include computer program instructions and other information for implementing aspects of the present disclosure. For example, in some embodiments, the memory 124 may include a speaker control service 166, which may be executed by the processing unit 126 to perform various operations. In some embodiments, the speaker control service 166 may implement various aspects of the present disclosure, for example, by utilizing sensor, input, or other information to determine whether to configure the first speaker 132 to operate as a group-listening speaker or as a personal-listening speaker and to determine whether to configure the second speaker 134 to operate as a group-listening speaker or to cause the second speaker 134 to become inactive or enter a low-power state The processes by which the speaker control service 166 utilizes to enable personal-listening mode or group-listening mode selectively are further described with reference to FIG. 10.

In some embodiments, the input/output interface 122 may also receive input from an input device 172, such as a keyboard, mouse, digital pen, microphone, touch screen, gesture recognition system, voice recognition system, image recognition through an imaging device (which may capture eye, hand, head, body tracking data and/or placement), gamepad, accelerometer, gyroscope, or another input device known in the art. In some embodiments, the at least one microphone 156 may be configured to receive sound from an analog sound source (e.g., the analog sound source 104 described with reference to FIG. 1). For example, the at least one microphone 156 may be configured to receive human speech. The at least one microphone 156 may further be configured to convert the sound into audio data or electrical audio signals that are directly or indirectly provided to the processing unit 126.

In some embodiments, the one or more sensors 150 may include, but are not limited to, one or more biometric sensors, heat sensors, chronological/timing sensors, geolocation sensors, gyroscopic sensors, accelerometers, pressure sensors, force sensors, light sensors, or the like. In such embodiment, the one or more sensors 150 may be configured to obtain sensor information from a user of the first audio device 102a and/or from an environment in which the first audio device 102a is utilized by the user. The processing unit 126 may receive sensor readings from the one or more sensors 150 and may generate one or more outputs based on these sensor readings. For example, the processing unit 126 may configure a light-emitting diode included on the audio system (not shown) to flash according to a preconfigured pattern based on the sensor readings.

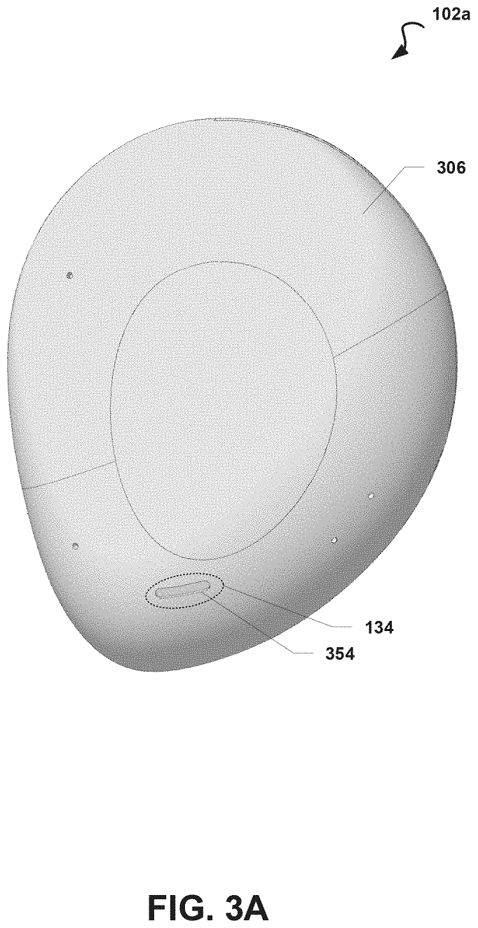

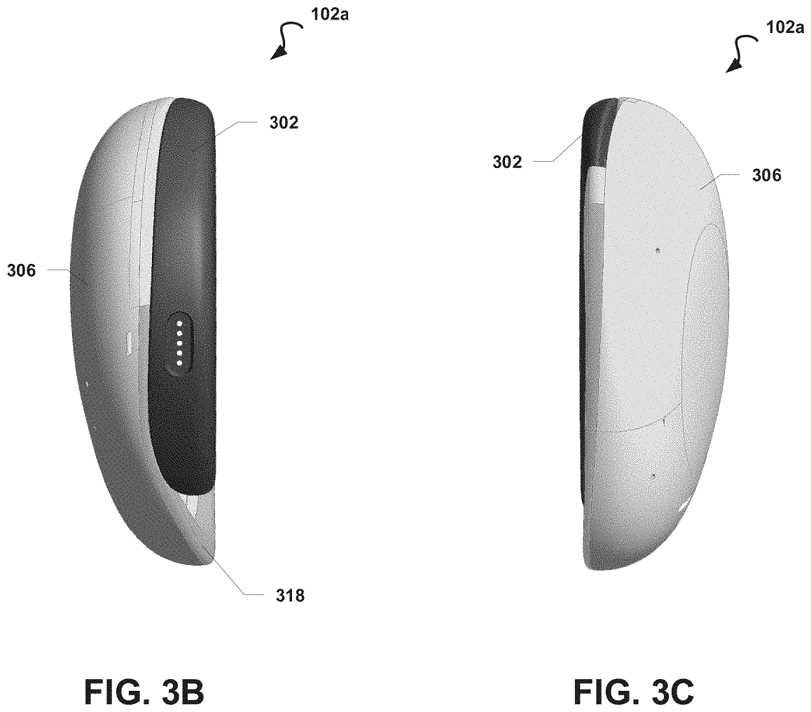

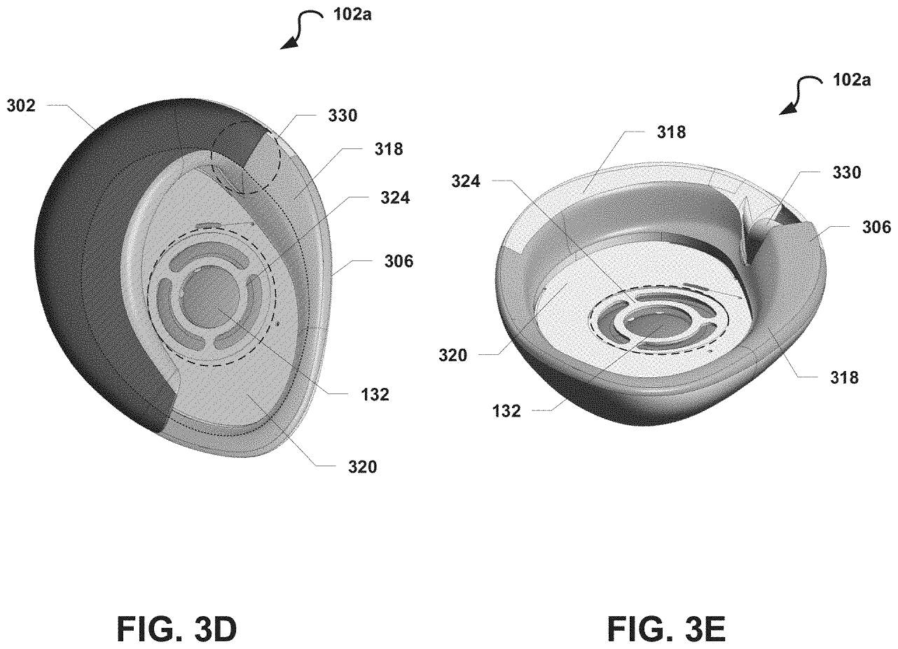

FIGS. 3A-3E illustrate exterior views of a first audio device 102a, according to some embodiments. FIG. 3A illustrates an exterior view of a front of the first audio device 102a. FIG. 3B illustrates an exterior view of a posterior side of the first audio device 102a while in a closed configuration. FIG. 3C illustrates an exterior view of an anterior side of the first audio device 102a while in a closed configuration. FIG. 3D illustrates an exterior view of a back side of the first audio device 102a while in an open configuration. FIG. 3E illustrates another exterior view of a back side of the first audio device 102a with a hooking member 302 of the first device 300 omitted. In some embodiments, the first audio device 102a may be configured the same or substantially the same as described with reference to the first audio device 102a illustrated in FIGS. 1A-2. Duplicative descriptions may be omitted for ease of description.

With reference to the examples illustrated in FIGS. 3A-3E, the first audio device 102a may include a plurality of structural features, including without limitation: a hooking body 302, a hinge 330, and a device body 306. The device body 306 may include a mid-ear portion 324.

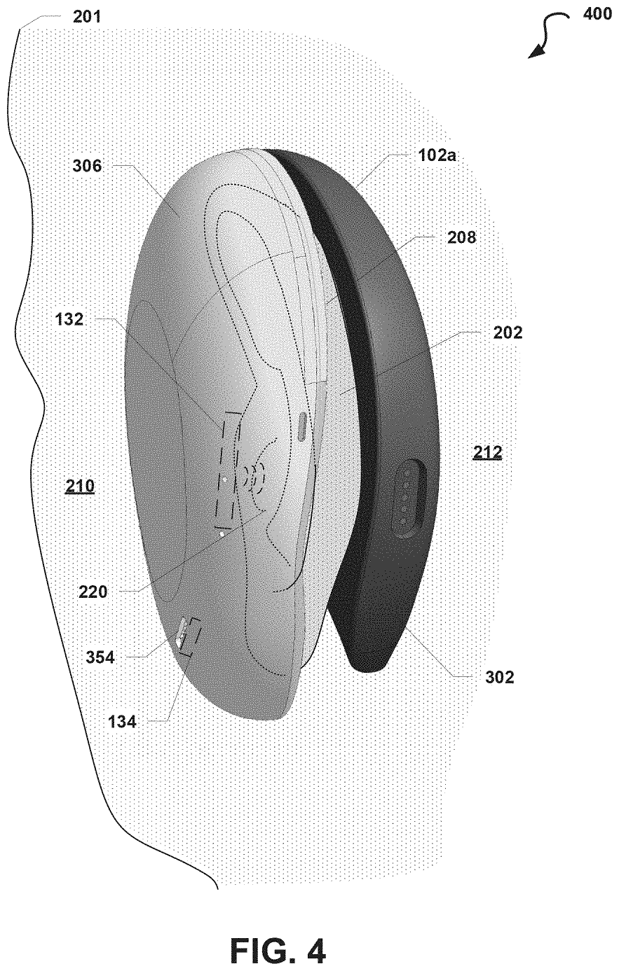

The hooking body 302 of the first audio device 102a may be configured to have a shape that approximates a profile of a root of a posterior portion of a human ear. This shape may be referred to generally as a C-shape. When the hooking body 302 is secured to the user's ear (e.g., as illustrated in FIG. 4), the hooking body 302 may be positioned proximal to and/or may engage a surface of a root of the posterior and/or top portion of the user's ear. The device body 306 may be configured to have a shape that approximates the profile of a human's outer ear, and as such, the device body 306 may be elliptical or roughly elliptical in shape. In some embodiments, the device body 306 may include or define a mid-ear portion 324 that is substantially positioned at a center or approximate center of the device body 306. In some embodiments, the mid-ear portion 324 may be configured to be suitable for receiving, coupling to, or otherwise accommodating a first speaker 132 that may be mounted to the mid-ear portion 324. For example, the mid-ear portion 324 may include one or more fasteners or mounting systems (not shown) that may be configured to couple to corresponding fasteners or mounting systems of a speaker system. In some embodiments, the mid-ear portion 324 may define an opening in the device body 306 that has a shape suitable for receiving or otherwise accommodating at least a portion of the first speaker 132. While the opening defined by the mid-ear portion 324 is illustrated in various corresponding drawings as having a substantially circular shape, in some embodiments, the mid-ear portion 324 may be configured to define an opening having one of various shapes, including but not limited to, circular, rectangular, elliptical, or various other shapes.

The first audio device 102a may include a hinge 330. In some embodiments, the device body 306 may be coupled to the hooking body 302 via the hinge 330. For example, the hinge 330 may be one of various types of hinges (e.g., a tension hinge). The hinge 330 may be configured to couple the device body 306 to the hooking body 302 so that movement of one of the device body 306 or the hooking body 302 is limited in relation to each other. In some embodiments (not shown), the hooking body 302 and the device body 306 may each include complementary magnetic elements that maintain the hooking body 302 and the device body 306 in the closed configured. As such, as the device body 306 is moved towards the hooking body 302, the complementary magnetic elements may pull towards each other, thereby urging the device body 306 and the hooking body 302 towards each other.

The hinge 330 may be formed from one or more portions of the hooking body 302 and the device body 306. In some embodiments, the hinge 330 may additionally include one or more other structural features. In a non-limiting example, the hinge 330 may be formed at least in part by a portion of the hooking body 302, a portion of the device body 306, a spring, a first anchor device configured to couple the portion of the hooking body 302 to the spring, and a second anchor device configured to couple the portion of the device body 306 to the spring. In some alternative (or additional) embodiments, the hinge 330 may be a separate structural feature that is separately coupled to the hooking body 302 and the device body 306. In a non-limiting example, the hinge 330 may include a housing configured to couple to a portion of the hooking body 302 and a portion of the device body 306 such that, while the hooking body 302 and the device body 306 are coupled to the hinge 330, the hinge 330 governs the movement of the hooking body 302 and the device body 306 in relation to one another.

The hinge 330 may be configured to enable the device body 306 to be moved (e.g., swung, rotated, or pivoted) away from the hooking body 302 to cause the first audio device 102a to transition from a closed configuration to an open configuration by rotating about a rotational axis (not shown). The hinge 330 may also be configured to enable the device body 306 to be moved (e.g., swung, rotated, or pivoted) back towards the hooking body 302, for example, to transition the first audio device 102a from an open configuration to a closed configuration by rotating in the opposite direction along the rotational axis.

In various embodiments described herein, the first audio device 102a may be described as transitioning from a closed configuration to an open configuration. However, the first audio device 102a may, in some additional or alternative embodiments, may be configured to transition from an open configuration to a closed configuration in a manner opposite of the manner described above with reference to transitioning from a closed configuration to an open configuration.

In some embodiments, the device body 306 may include or be coupled to an edge member 318. The edge member 318 may include or be made from one or more materials that are suitable for physically engaging a user's ear and/or portions of the user's face. In such embodiments, while the first audio device 102a is secured to a user's ear (e.g., as illustrated in FIG. 4), the edge member 318 may press against the user's ear and/or portions of the user. In some embodiments, the edge member 318 may be configured to form a recessed area 320 (e.g., as illustrated in at least FIG. 3E), and an ear pad (not shown) may be positioned within the recessed area 320. In some additional or alternative embodiments, the ear pad may be configured so that the ear pad fills a portion of the recessed area 320 and does not extend beyond the edge member 318 towards the hooking body 302. In some embodiments, the device body 306 may include or be coupled to the first speaker 132. The first speaker 132 may be obscured by (e.g., covered by) an ear pad (not shown). In some embodiments, the first speaker 132 may be configured to produce sound that is directed into the recessed area 320.

In some embodiments, the ear pad may be coupled to, attached to, or positioned towards a back-facing side of the device body 306. The ear pad may include or may be made from one or more materials, such as one or more soft, pliable materials suitable for physically engaging a human ear. In some embodiments, while the first audio device 102a is configured in an open configuration, a posterior portion of the user's ear may be inserted between the hooking body 302 and the device body 306 (e.g., as described above). When the first audio device 102a transitions from an open configuration to a closed configuration, the device body 306 may move towards the hooking body 302, thereby causing the ear the occupy at least a portion of the recessed area 320.

In some embodiments, the device body 306 may include a touch-sensitive sensor or sensors (not shown). By way of a non-limiting example, the touch sensitive sensor or sensors may be a capacitive touch sensor or one or more other touch sensitive sensors known in the art. In such embodiments, the device body 306 may be made from a material suitable for enable the touch-sensitive sensor or sensors to measure changes in electrical properties, such as when a user's finger touches the device body 306.

In some embodiments (e.g., as illustrated in FIG. 3A), the device body 306 may include a second speaker 134. As further described herein, the second speaker 134 may be positioned near an opening 354 in the device body 306. The opening 354 may include one or more openings that are suitable for enabling sound generated from the second speaker system 134 to pass through the opening 354 into the surroundings.

FIG. 4 illustrates an exterior view of an environment 200 in which an audio device (e.g., the first audio device 102a described with reference to FIGS. 1A-1H) is configured to operate in a personal-listening mode while secured to an outer ear 202 of a user 201, according to some embodiments. Specifically, FIG. 4 illustrates an exterior perspective view of a posterior side of the first audio device 102a while the first audio device 102a is secured to the outer ear 202 and configured in a partially closed configuration.

As described, in some embodiments, the first audio device 102a may be secured to a user's outer ear 202. While secured on the user's outer ear 202, the first audio device 102a may be configured to operate in a personal-listening mode whereby the first speaker 132 is configured to operate as a full-range, personal-listening speaker. Specifically, because the first speaker 132 is positioned near an interior portion 220 of the user's outer ear 202, the first speaker 132 may be configured to output sound in a wide range of frequencies and at a relatively low volume so that the user 201 may comfortably enjoy a full-range of sound coming from the first speaker 132. While the first audio device is configured in a personal-listening mode, the second speaker 134 may not be used to output sound and, in some embodiments, may instead be caused to operate in a low power state.

With reference to the example illustrated in FIG. 4, the first audio device 102a may be secured to the outer ear 202, which may include a posterior portion 208 and an interior portion 220. While the first audio device 102a is secured to the outer ear 202, an anterior side of the first audio device 102a may face an anterior side 210 of the user 201, and a posterior side of the first audio device 102a may face a posterior side 212 of the user 201. In some embodiments, the device body 306 may cover all or substantially all of the user's outer ear 202. Accordingly, when viewed from a front side of the first audio device 102a (or side of a user's face), the device body 306 may completely (or substantially) obscure the outer ear 202 when the first audio device 102a is secured to the outer ear 202.

In some embodiments, the hinge 330 (not shown) may urge the device body 306 and the hooking body 302 towards each other, and the device body 306 and the hooking body 302 may collectively apply a compressive force to the posterior portion 208 of the outer ear 202 that may ensure that the first audio device 102a is secured to the outer ear 202.

The hooking body 302 and the device body 306 of the first audio device 102a may be configured collectively so that the first audio device 102a may be worn on and secured to the outer ear 202. The first audio device 102a may be configured in an open configuration (e.g., by moving the hooking body 302 away from the device body 306 via the hinge 330) so that a space or gap is present between the hooking body 302 and the device body 306. The first audio device 102a may then be placed on the outer ear 202 by hooking, hanging, or otherwise positioning the hooking body 302 along the root of the upper portion 204 of the outer ear 202 and by rotating the hooking body 302 until the hooking body 302 engages the root of the posterior portion 208 of the outer ear 202. Because the first audio device 102a features a space or gap between the hooking body 302 and the device body 306 while the first audio device 102a is in an open configuration, the posterior portion 208 of the outer ear 202 may move into, at least partially, in such space or gap and remain in such space or gap once the hooking body 302 engages the root of the posterior portion 208 of the outer ear 202 (e.g., as shown in the example illustrated in FIG. 4). In a non-limiting example, the device body 306 and the rotational axis of the hinge 330 may be configured so that the device body 306 is positioned upward and away from the outer ear 202 while the first audio device 102a is configured in an open configuration. In some further embodiments, padding or other comfortable material may be attached to a surface of the device body 306 that engages the interior portion 220 or another portion of the outer ear 202 to improve comfort while the first audio device 102a is secured to the outer ear 202.

While the hooking body 302 is hooked onto the outer ear 202 and while the first audio device 102a is configured in an open configuration, the device body 306 may be moved (e.g., swung) towards the hooking body 302. As the device body 306 continues moving towards the hooking body 302, the space or gap between the hooking body 302 and the device body 306 may decrease in at least one dimension until the device body 306 physically contacts at least the posterior portion 208 of the outer ear 202. In some embodiments, once the device body 306 contacts the posterior portion 208 of the outer ear 202, the device body 306 may begin pressing the posterior portion 208 against the hooking body 302, generating a compressive force that secures the posterior portion 208 of the outer ear 202 between the device body 306 and the hooking body 302. For ease of description, the first audio device 102a may be described herein as being configured in a partially closed configuration while the posterior portion 208 of the outer ear 202 is secured between the device body 306 and the hooking body 302.

When the device body 306 is moved (e.g., swung) so that the first audio device 102a transitions to the closed position, the mid-ear portion 324 of the device body 306 may move into proximity of the interior portion 220 of the outer ear 202. In some embodiments, the first speaker 132 may move nearer to the interior portion 220 of the outer ear 202, thereby enabling the user 201 to experience sound generated from the first speaker 132. For example, when the first audio device 102a is secured to the user's ear, the first speaker 132 may be positioned in proximity to the interior portion of the ear (e.g., close to the meatus of the user's ear canal) so that audio played through the first speaker 132 is directed towards the ear canal. In such embodiments, the first speaker 132 may be positioned at a predetermined angle so that sound outputted from the first speaker 132 is directed towards the meatus of the user's ear canal when the first audio device 102a is secured to the user's ear.

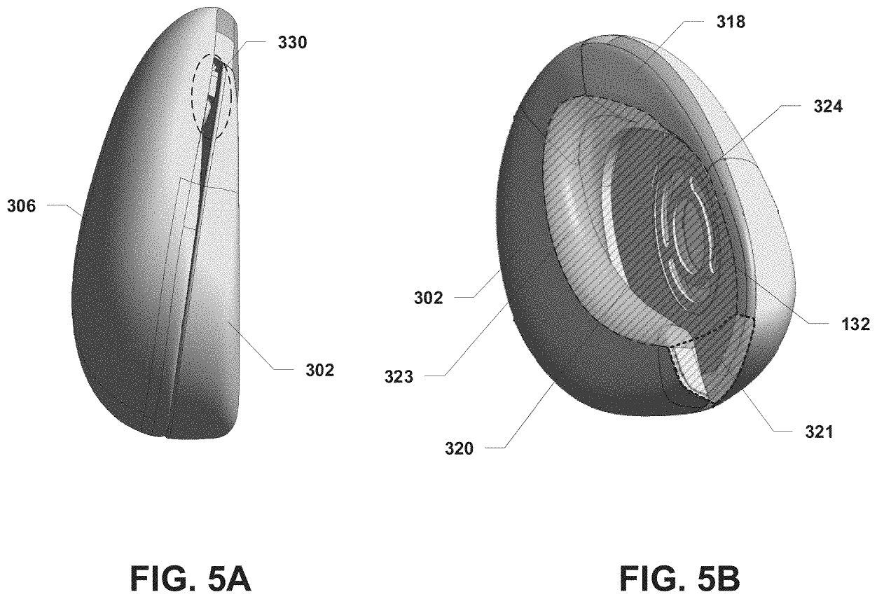

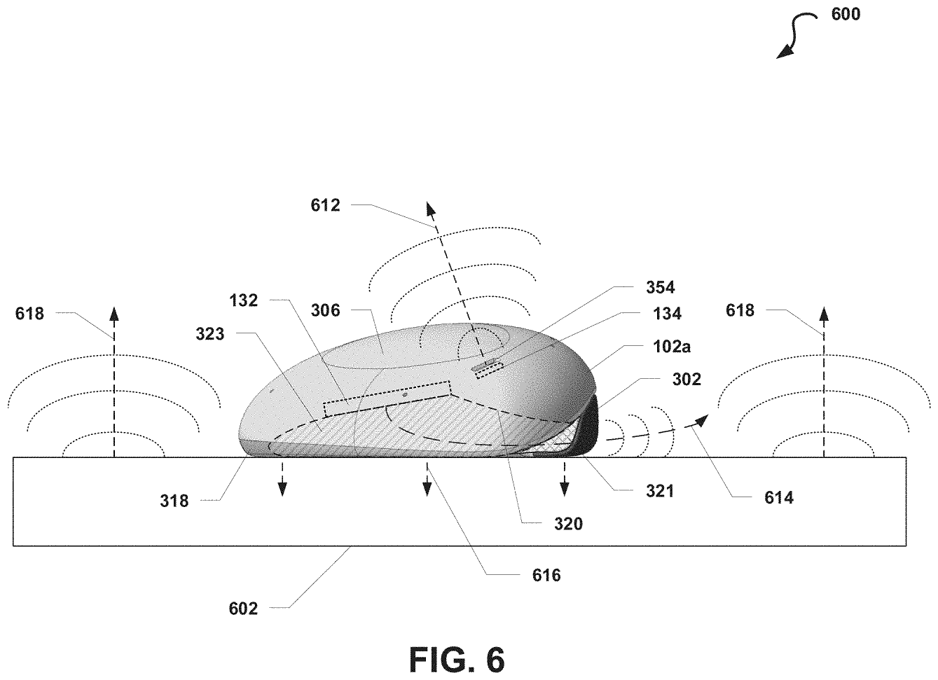

FIGS. 5A-6 illustrate exterior views of the first audio device 102a (e.g., the first audio device 102a described with reference to FIGS. 3A-4) configured to operate in a group-listening mode, according to some embodiments. Specifically, FIGS. 5A-5B illustrate exterior views of an acoustic chamber 323 formed at least in part by the recessed area 320 of the device body 306 and at least in part by the hooked body 302. FIG. 6 illustrates an operational environment 600 in which the first audio device 102a is resting on a surface of an object 602. While configured to operate in group-listening mode, the first audio device 102a may not be secured to the user's ear to avoid damaging the user's hearing.

With reference to the examples illustrated in FIGS. 5A-6, when the first audio device 102a is configured to operate in a group-listening mode, the first speaker 132 may be configured to operate as a low-range, group-listening speaker. Specifically, the first speaker 132 may be configured to generate sounds having frequencies in a lower portion of the range of human hearing (e.g., without limitation, frequencies between 20 Hz and 2000 Hz). The first speaker 132 may be configured to generate these sounds at a volume that may be experienced by users within the immediate area of the first audio device 102a. The second speaker 134 may be configured to generate sounds having frequencies in a higher portion of the range of human hearing (e.g., without limitation, frequencies between 2000 Hz and 20,000 Hz). The second speaker 134 may be configured to generate these sounds at a volume that may also be experienced by users within the immediate area of the first audio device 102a.

As described, the first audio device 102a may be powered by a battery (not shown). To achieve an increase in power usage efficiency of the first audio device 102a and thus a longer battery life, the first speaker 132 may be configured to have one or more characteristics that may enable the first speaker 132 to generate low-range frequencies more efficiently than the second speaker 134. By way of a non-limiting example, the first speaker 132 may be larger than the second speaker 134 (e.g., a 40 mm speaker driver v. a micro speaker) so that the first speaker 132 may generate lower frequencies using less energy than the energy the second speaker 134 would require to generate the lower frequency sounds. The first speaker 132 may also, or alternatively, be configured to generate lower frequency sounds with less distortion than lower-frequency sounds that could be generated by the second speaker 134.

In some embodiments, the second speaker 134 may be configured to have one or more characteristics that enable the second speaker 134 to generate high-range frequencies more efficiently than the first speaker 132. In a non-limiting example, the second speaker 134 may be a micro-speaker with a form factor than is smaller than the first speaker 132, which may, in this example, be a 40 mm speaker. Due to smaller form factor of the second speaker 134, the second speaker 134 may generate high-range frequencies using less power than the power required for the first speaker 132 to generate the same high-range frequencies. Further, in some embodiments in which the first audio device 102a is portable, the combination of the smaller form factor of the second speaker 134 and the larger form factor of the first speaker 132 may enable the audio device to produce a high-quality sound using comparatively less power while keeping the overall weight of the first audio device 102a down.

With reference to the examples illustrated in FIGS. 5A-5B, when the first audio device 102a is configured in a closed configuration such that the hooking body 302 is physically in contact with the edge member 318 of the device body 306, the hooking body 302 and the edge member 318 of the device body 306 may be collectively configured so that the hooking body 302 and the edge member 318 are at least substantially flat in relation to each other. In some embodiments, the hooking body 302 and/or the edge member 318 may form a discontinuity in the at least substantially flat profile of the hooking body 302 and the edge member 318 that functions as an acoustic opening in an acoustic chamber formed when the first audio device 102a is placed on the surface of an object (e.g., as described with reference to FIG. 6).

With reference to FIG. 6, the first audio device 102a may be placed on a surface of an object 602 such that the hooking body 302 and the edge member 318 of the device body 306 physically engage the surface of the object 602. In the example illustrated in FIG. 6, the surface of the object 602 is at least substantially flat. In some embodiments, the recessed area 320 of the device body 306, the surface of the object 602, and the edge member 318 may collectively form an acoustic chamber 323. As described (e.g., with reference to FIGS. 5A-5B), the hooking body 302 and the device body 306 and/or edge member 318 may be configured collectively such that an opening 321 to the acoustic chamber 323 is formed when the first audio device 102a is placed against the surface of the object 602.

In some embodiments, the first speaker 132 may output sound into the acoustic chamber 323. The acoustic chamber 323 may function as a front volume for the first speaker 132, enabling the first speaker 132 to use the air in the acoustic chamber 323 to generate sound relatively efficiently. When the first audio device 102a is operating in a group-listening mode such that the first speaker 132 is configured to operate as a low-range, group-listening speaker, low-frequency sound generated from the first speaker 132 may be directed into the acoustic chamber 323, and the sound may exit the acoustic opening 321 into the ambient air (e.g., in a direction indicated by dotted line 614). In some embodiments, the acoustic chamber 323 and the acoustic opening 321 (and possibly the surface of the object 602) may function essentially as an acoustic horn that collectively improve impedance matching, bass response, and power consumption of the first speaker 132 while also effectively directing sound away from the first audio device into the ambient air. In some additional (or alternative) embodiments, the acoustic chamber 323 and acoustic opening 321 may function as a Helmholtz resonator, thereby enabling the first speaker 132 to generate low-frequency sounds effectively and with less power. At the same time the first speaker 132 is generating low-frequency sounds, the second speaker 134 may be configured to generate synchronized, high-frequency sound that is directed away from the first audio device via the opening 354 (e.g., in a direction indicated by dotted line 612).

In some embodiments (e.g., as illustrated in FIG. 6), the first audio device 102a may make substantial physical contact with the surface of the object 602 via the hooking body 302 and the edge member 318 of the device body 306. As a result of this physical contact with the surface of the object 602, the low-frequency sounds generated by the first speaker 132 may pass through the physical structure of the first audio device 102a into the object 602. Accordingly, the first speaker 132 may cause the object 602 to begin resonating due to the vibrational energy entering the object 602 from the first audio device 102a (e.g., as illustrated by dotted lines 616). The object 602 may then cause air near the surface of the object 602 to begin vibrating, thereby creating additional low frequency sounds that travel into the ambient air (e.g., as indicate by dotted lines 618), thereby increasing the overall bass response of the first audio device 102a.

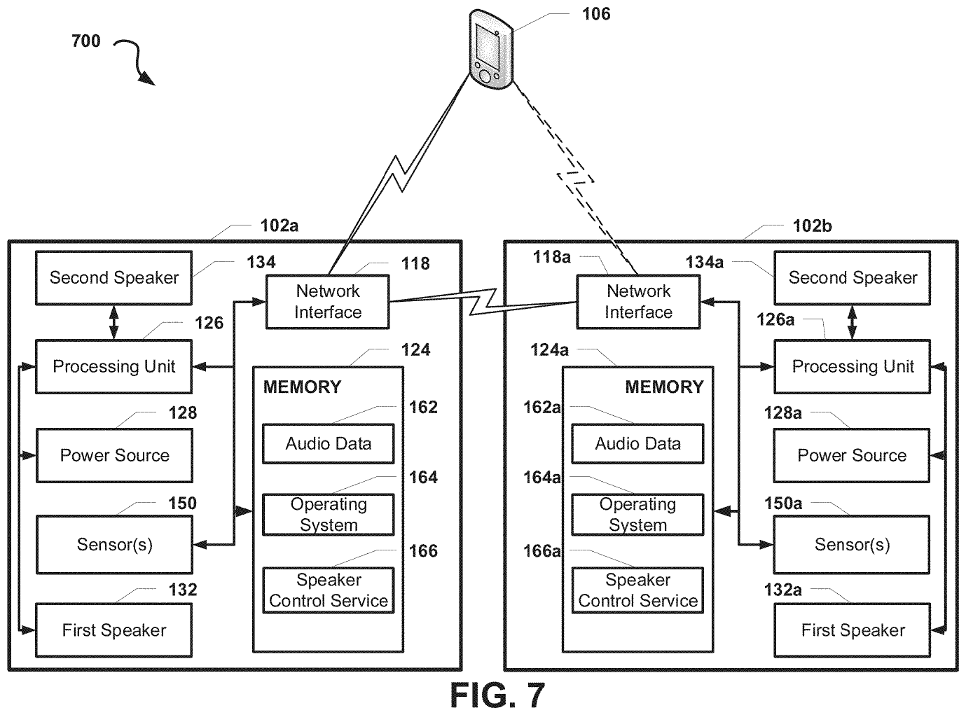

FIG. 7 depicts general architecture of the first audio device 102a and the second audio device 102b, which includes an arrangement of computer hardware and software components that may be used to implement aspects of the present disclosure, according to some embodiments. The first audio computing device 102a and the first audio device 102b may include many more (or fewer) elements than those shown in FIG. 7. It is not necessary, however, that all of these generally conventional elements be shown in order to provide an enabling disclosure.

In some embodiments, the first audio device 102a may be configured as described above (e.g., with reference to FIG. 2). In some embodiments, the second audio device 102b may be a mirror-image of the first audio device 102a and thus may be configured similarly to the first audio device 102a. Accordingly, the second audio device 102b may be configured to include components similar to or the same as one or more of the structural or functional components described above with reference to the first audio device 102a. By way of a non-limiting example, the second audio device 102b may include an input/output device interface (not shown), a network interface 118a, least one microphone 156a (not shown), a memory 124a, a processing unit 126a, a power source 128a, an optional display (not shown), a first speaker 132a, a second speaker 134a, and one or more sensors 150a, all of which may communicate with one another by way of a communication bus. The network interface 118a may provide connectivity to one or more networks or computing systems, and the processing unit 126a may receive and/or send information and instructions from/to other computing systems or services via the network interface 118a. For example (as illustrated in FIG. 7), the network interface 118a may be configured to communicate with the network interface 118 of the first audio device 102a. In some alternative (or additional) embodiments, the network interface 118a may be configured to communicate with the mobile computing device 106 and/or one or more other computing devices (not shown) via wireless communication links, such as via a Wi-Fi Direct or Bluetooth communication links. The network interface 118a may also (or alternatively) be configured to communicate with one or more computing devices via a wired communication link (not shown). In some embodiments, the network interface 118a may receive audio data from one or more other computing devices and may provide the audio data to the processing unit 126a. In such embodiments, the processing unit 126a may cause the audio data to be transformed into an electrical audio signal that is provided to the first speaker 132a and/or the first speaker 132a and the second speaker 134a for output as sound.

The processing unit 126a may communicate to and from memory 124a. In some embodiments, the memory 124a may include RAM, ROM, and/or other persistent, auxiliary or non-transitory computer-readable media. The memory 124a may store an operating system 164a that provides computer program instructions for use by the processing unit 126a in the general administration and operation of the second audio device 102b. In some embodiments, the memory 124a may contain digital representations of audio data 162a or electronic audio signals (e.g., digital copies of songs or videos with audio). In such embodiments, the processing unit 126a may obtain the audio data 162a or electronic audio signals from the memory 124a and may provide electronic audio signals to the first speaker 132a and/or the second speaker 134a for playout as sound.

In some embodiments, the memory 124a may further include computer program instructions and other information for implementing aspects of the present disclosure. For example, in some embodiments, the memory 124a may include a speaker control service 166a, which may be executed by the processing unit 126a to perform various operations. In some embodiments, the speaker control service 166a may implement various aspects of the present disclosure, for example, by utilizing sensor, input, or other information to determine whether to configure the first speaker 132a to operate as a group-listening speaker or as a personal-listening speaker and to determine whether to configure the second speaker 134a to operate as a group-listening speaker or to cause the second speaker 134a to become inactive or enter a low-power state The processes by which the speaker control service 166a utilizes to enable personal-listening mode or group-listening mode selectively are further described with reference to FIG. 10.

In some embodiments, the input/output interface of the second audio device 102b may also receive input from an input device in communication with the second audio device 102b, such as a keyboard, mouse, digital pen, microphone, touch screen, gesture recognition system, voice recognition system, image recognition through an imaging device (which may capture eye, hand, head, body tracking data and/or placement), gamepad, accelerometer, gyroscope, or another input device known in the art. In some embodiments, the at least one microphone of the second audio device 102b may be configured to receive sound from an analog sound source

In some embodiments, the one or more sensors 150 of the first audio device 102a and the one or more sensors 150a of the second audio device 102b may include one or more sensors that may detect when the first audio device 102a is coupled to the second audio device 102b. By way of a non-limiting example, the sensors 150, 150a may include proximity sensors, Hall effect sensors paired with magnetic elements on the other audio device, or the like. In some embodiments, the speaker control service 166 may cause the first audio device 102a to operate in (or may enable) a personal-listening mode in response to determining that the first audio device 102a is not coupled to the second audio device 102b. The speaker control service 166 may cause the first audio device 102a to operate (or may otherwise enable) a group-listening mode in response to determining that the first audio device 102a is coupled to the second audio device 102b, for example, by determining that one or more of the sensors 150 (e.g., a Hall-effect sensor) has detected a magnetic field generated by a component of the second audio device 102b.

In some embodiments, the one or more sensors 150 of the first audio device 102a and the one or more sensors 150a of the second audio device 102b may include one or more sensors that may detect when the first audio device 102a and/or the second audio device 102b are in the closed configuration, in the open configuration or in a partially closed configuration (such as when the audio devices 102a, 102b are secured to a user's ear). By way of a non-limiting example, the sensors 150, 150a may include proximity sensors or Hall effect sensors to sense a configuration of the audio devices 102a, 102b. In some embodiments, the speaker control service 166 may cause the first audio device 102a to operate in (or may enable) a personal-listening mode in response to determining that the first audio device 102a is in the partially closed configuration associated with the first audio device 102a being secured to a user's ear. The speaker control service 166 may cause the first audio device 102a to operate (or may otherwise enable) a group-listening mode in response to determining that the first audio device 102a is in the completely closed configuration.

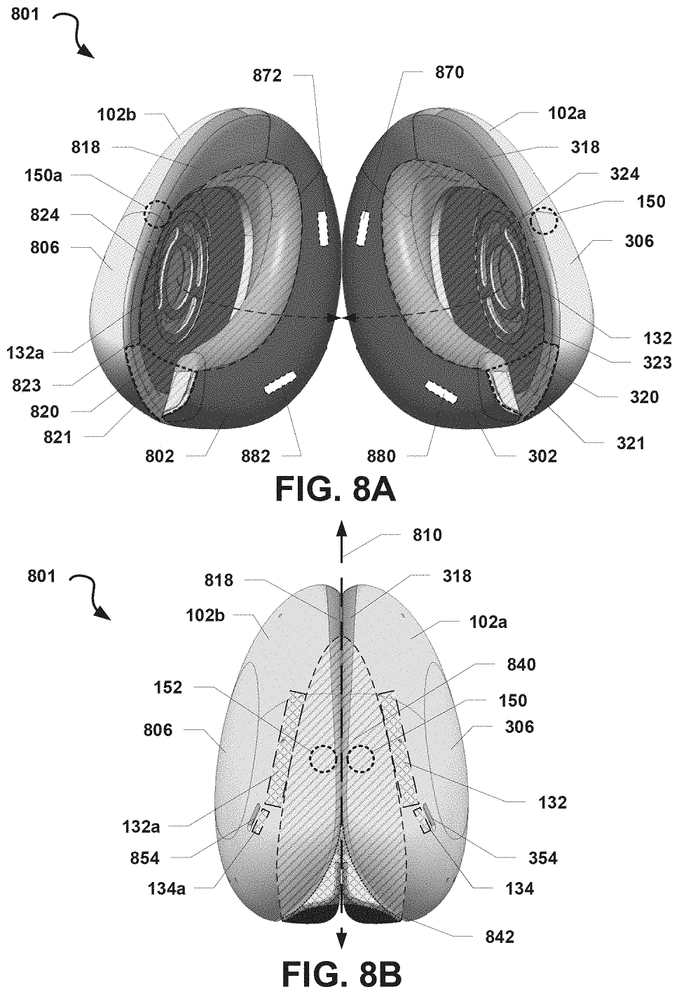

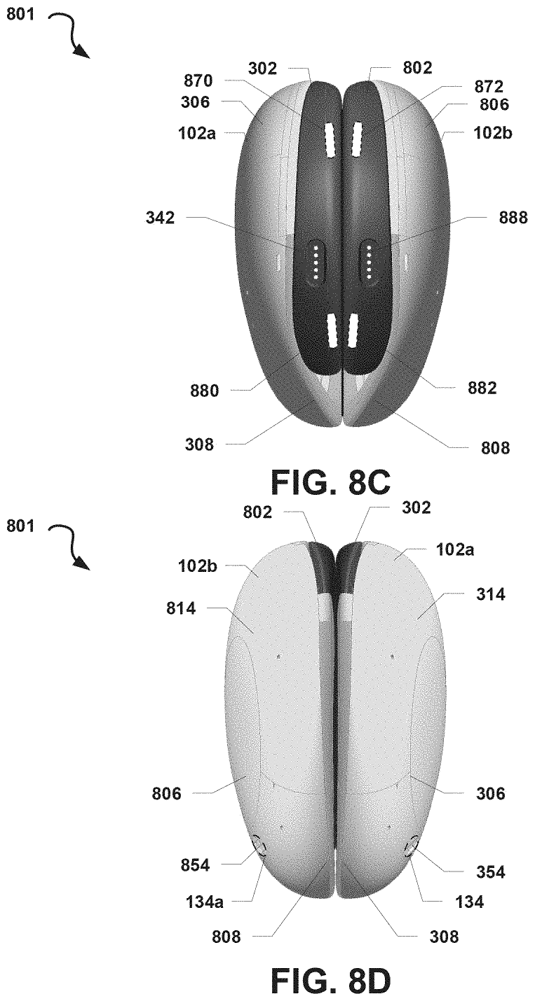

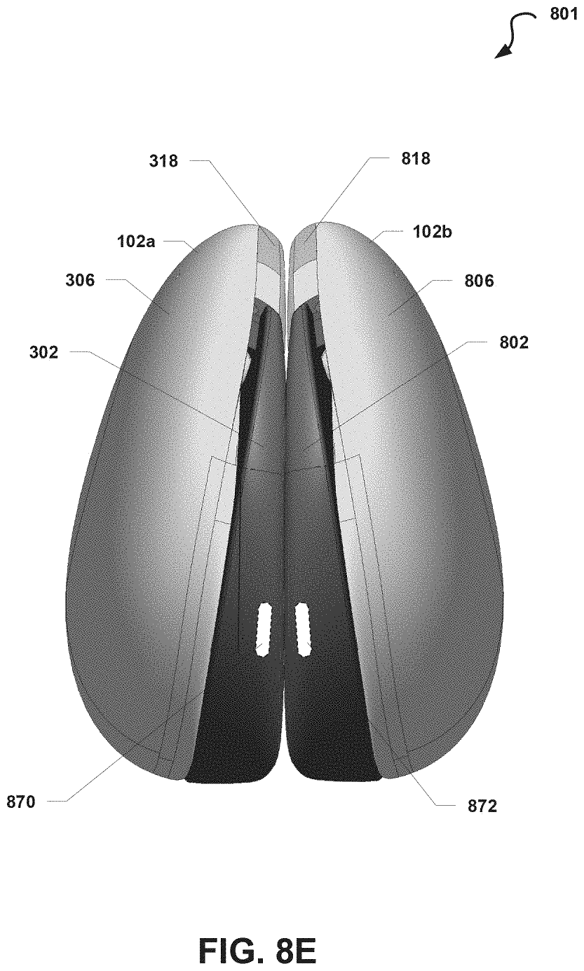

FIGS. 8A-8E illustrate exterior views of an audio system 801 that include the first audio device 102a and another second audio device 102b. FIG. 8A illustrates a bottom view of the audio system 801 in which the first audio device 102a and the second audio device 102b are not coupled together. FIG. 8B illustrates a bottom view of the audio system 801 in which the first audio device 102a and the second audio device 102b are coupled together. FIG. 8C illustrates a posterior view of the audio system 801 when the first audio device 102a and the second audio device 102b are coupled together. FIG. 8D illustrates an anterior view of the audio system 801 when the first audio device 102a and the second audio device 102b are coupled together. FIG. 8E illustrates a top view of the audio system 801 when the first audio device 102a and the second audio device 102b are coupled together.

With reference to FIGS. 8A-8E. The first audio device 102a may be configured according to various embodiments previously described herein (e.g., with reference to FIGS. 1A-7). The second audio device 102b may be configured as a mirror-image of the first audio device 102a. In some embodiments, the second audio device 102b may include, but is not limited to including: a hooking body 802, a device body 806, a charging connector 888, an edge member 818, a mid-ear portion 824, an opening 854, the first speaker 132a, and the second speaker 134a. For ease of description, duplicative descriptions of such elements are omitted. In some embodiments (not shown), the second audio device 102b may include one or more other features or components that are configured as mirror images of features or components of the first audio device 102a, including but not limited to, a processing unit, ear pad, ear-fitting attachment, or various other elements or features similar to those described as being included or coupled to the first audio device 102a (e.g., as described with reference to FIGS. 1-7).

The audio devices 102a, 102b may be configured to be coupleable together. In some embodiments, the audio devices 102a, 102b may be configured to include one or more coupling devices in their respective hooking bodies 302, 802. Specifically, in the example illustrated in FIG. 8A, the hooking body 302 may include or be coupled to a first coupling device 870 positioned near a top of the hooking body 302 and a second coupling device 880 positioned near a bottom of the hooking body 302. Similarly, the hooking body 802 may include or be coupled to a third coupling device 872 positioned near a top of the hooking body 802 and a fourth coupling device 882 positioned near a bottom of the hooking body 802. The audio devices 102a, 102b may be coupled together (e.g., as illustrated in FIGS. 8B-8E) by causing the first and third coupling devices 870, 872 to engage and/or by causing the second and fourth coupling devices 880, 882 to engage. The coupling devices 870, 872, 880, 882 may be one or more (or a combination of) fasteners, magnets, snaps, or the like. By way of a non-limiting example, the coupling devices 870, 872, 880, 882 may be magnets, whereby at least the first coupling device 870 has a different magnetic polarity from the third coupling device 872 and the second coupling device 880 has a different magnetic polarity from the fourth coupling device 882. One or more other coupling devices may be utilized to couple the audio devices 102a, 102b together. The coupling devices 870, 872, 880, 882 may also be configured to allow the audio devices 102a, 102b to be decoupled, for example, when the audio devices 102a, 102b are pulled apart (e.g., along different directions).

In some embodiments, the audio devices 102a, 102b may be in electronic communication with each other (e.g., via a wireless communication signal, such as Bluetooth or near-field magnetic induction). In such embodiments, respective processing units (not show) of the audio devices 102a, 102b may coordinate in order to play out synchronized sound of at least one of speakers 132, 134 with the sound played from at least one of speakers 132a, 134a. In some embodiments, the respective processing units of the audio devices 102a, 102b may communicate a state of their respective audio devices 102a, 102b that may enable those processing units to cause their respective audio devices 102a, 102b to operate in the same state. For example, a processing unit of the first audio device 102a may notify a processing unit of the second audio device 102b that the first audio device 102a has begun operating in a group-listening mode, and the processing unit of the second audio device 102b may then cause the second audio device 102b to begin operating in a group-listening mode. The processing units of the audio devices 102a, 102b may similarly coordinate with respect to operating in a personal-listening mode. As a result, the playout of the speakers 132, 134 of the first audio device 102a may be synchronized or at least coordinated with playout of the speakers 132a, 134a of the second audio device 102b.

In some embodiments, the first audio device 102a and the second audio device 102b may, respectively, include sensors 150, 150a. Each of the sensors 150, 150a may be configured to detect the presence of the other sensor or another element. The sensors 150, 150a may be in communication with a processing unit on their respective audio devices 102a, 102b. In some embodiments, when the sensors 150, 150a detect each other (or another element in the other audio device), the sensors 150, 150a may send a signal indicating that the audio devices 102a, 102b are coupled together. In response, the processing units may selectively change the behavior of features or components on their respective audio devices 102a, 102b, such as the speaker 132, 132a. For example, the speaker systems 132, 132a may be playing out sound as full-range, personal-listening speakers while the audio devices 102a, 102b are not coupled together (e.g., when the sensors 150, 150a do not detect the presence of each other), but the processing units may cause the speaker systems 132, 132a to operate as low-range, group-listening speakers when the audio devices 102a, 102b are coupled together (e.g., when the sensors 150, 150a do detect the presence of each other) and, optionally, in response to receiving an input (e.g., from the mobile device 106 in communication with at least one of the audio devices 102a, 102b). In some embodiments, the processing units may selective activate features or components on their respective audio devices 102a, 102b when the sensors 150, 150a do not detect the presence of each other. By way of a non-limiting example, the audio devices 102a, 102b may be in a low-power or “standby” state while they are coupled to each other, but upon decoupling, the processing units may activate or resume operations, activities, functions, features, etc. For example, in response to determining that the sensors 150, 150a no longer detect each other, the processing units may resume communications with each other (and/or another electronic device) and may resume playing out sound via the speaker system 132 in first audio device 102a and a similar situated speaker system 132a in second audio device 102b.

In some embodiments, at least one of the audio devices 102a, 102b may communicate information indicating whether the audio devices 102a, 102b are coupled together to a computing device in communication with at least one of the audio devices 102a, 102b (e.g., the mobile computing device 106). The mobile computing device 106 may use the information to enable a group-listening option presented to a user (e.g., a user input element, such as a virtual button, toggle, or the like). In response to receiving a user input selecting the group-listening option, the mobile computing device 106 may send a signal to at least one of the audio devices 102a, 102b that may cause the audio devices 102a, 102b to begin operating in a group listening mode. Similarly, the mobile computing device 106 may send a signal to at least one of the audio devices 102a, 102b (e.g., in response to receiving a user input selecting a personal-listening mode) that may cause the audio devices 102a, 102b to begin operating in a personal-listening mode.

In some embodiments (e.g., as illustrated in FIG. 8A), the second audio device 102b may include a recessed portion 820 formed at least in part by the device body 806, the edge member 818. The recessed area 820 and the hooking body 802 may form an acoustic chamber 823 and an acoustic opening 821 as generally described with reference to the acoustic chamber 323 and the acoustic opening 321 of the first audio device 102a. As illustrated in FIGS. 8B-8E, when the first audio device 102a and the second audio device 102b are coupled together (e.g., via the coupling devices 870, 872, 880, 882) the hooking bodies 302, 802 and edge members 318, 818 of the device bodies 306, 806 may physically engage such that the acoustic chambers 323, 823 form a combined acoustic chamber 840 and the acoustic openings 321, 821 form a combined acoustic opening 842.

In some embodiments, sound that is played out from the first speaker 132 of the first audio device 102a and the first speaker 132a of the second audio device 102b may enter the combined acoustic chamber 840 and may mix and/or to combine in the acoustic chamber 840. The audio played out from the first speaker 132 and the first speaker 132a may be configured to have a power, volume, or gain having a first value. The sound from each of the first speakers 132, 132a may mix in the acoustic chamber 840 and may be passively amplified due to through audio signal addition, constructive interference, and/or sound reinforcement. The resulting sound may have a power, volume, or gain having a second value greater than the first value. In some embodiments, the first speaker 132 and the first speaker 132a may be configured such that first audio played from the first speaker 132 is in phase with second audio played from the first speaker 132a. As a result, the first audio may combine with the second audio via constructive interference to produce a resulting audio having a higher amplitude/volume than the first audio or the second audio individually. In some embodiments, the speakers 132, 132a may be configured to operate as low-range, group-listening speakers, and low-frequency sounds generated by the speakers 132, 132a may be amplified as described above in the combined acoustic chamber 840.

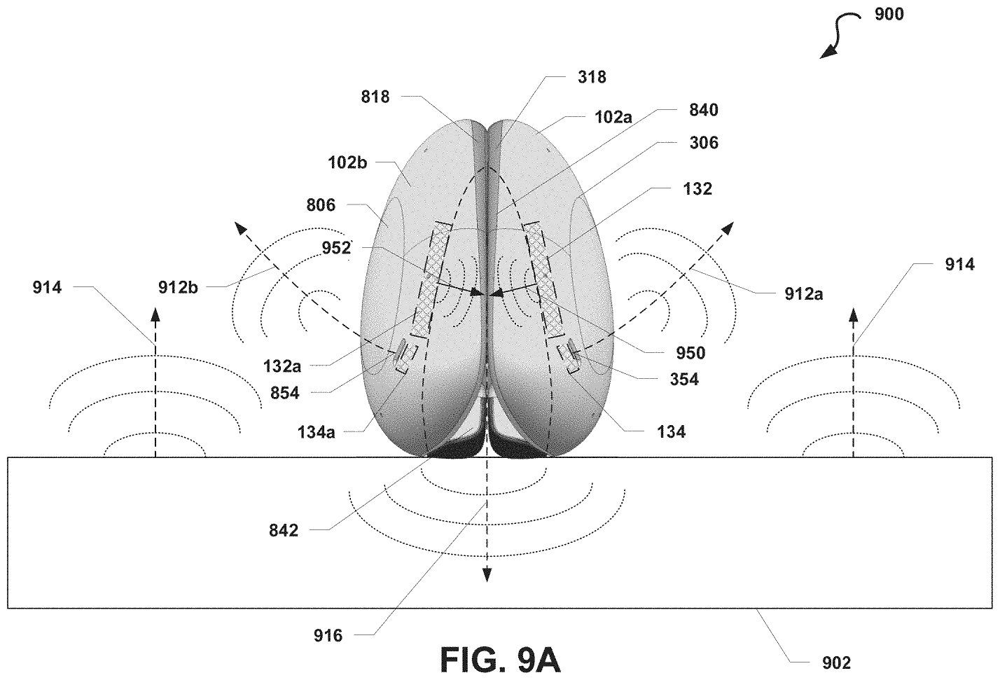

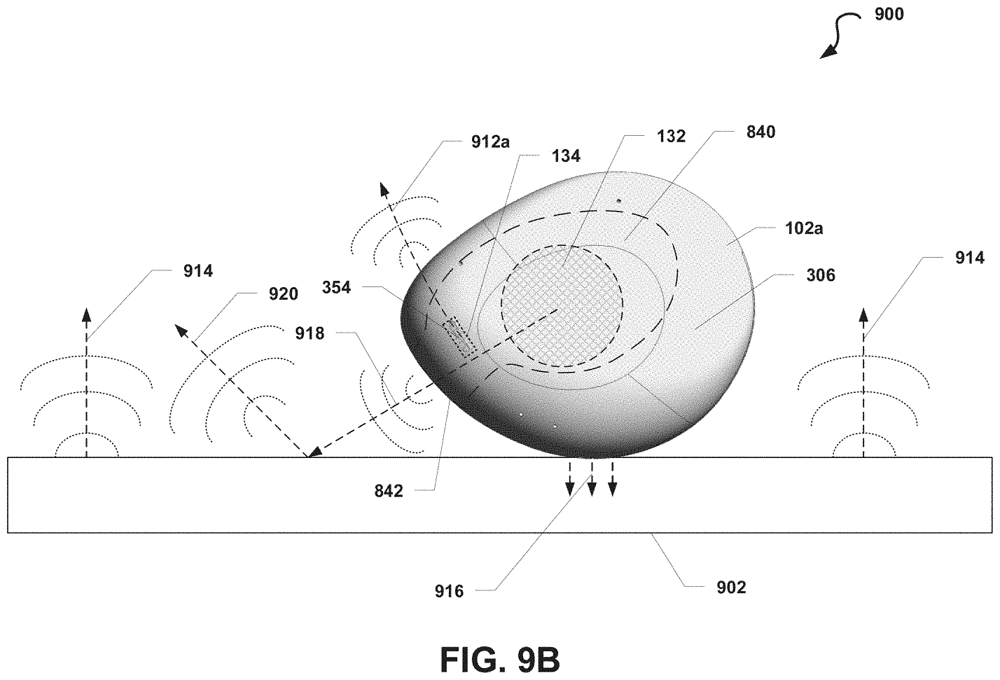

FIGS. 9A-9B illustrate an operational environment 900 in which the first audio device 102a (e.g., as described with reference to FIGS. 1-8E) is coupled to the second audio device 102b (e.g., as described with reference to FIGS. 1, 2, 7-8E), the audio devices 102a, 102b are resting on a surface of an object 902, and each of the audio devices 102a, 102b are configured to operate in a group-listening mode. FIG. 9A illustrates an exterior view of a bottom side of the first audio device 102a and the second audio device 102b. FIG. 9B illustrates an exterior view of a front side of the first audio device 102a, while the first audio device 102a is obscuring the second audio device 102b.

As described, the first speaker 132 of the first audio device 102a and the first speaker 132a of the second audio device 102b may be configured to play out audio into the combined acoustic chamber 840. In some embodiments, the first speaker 132 and the first speaker 132a may be respectively oriented within the first audio device 102a and the second audio device 102b such that audio 950 that is played out from the first speaker 132 and audio 952 that is played out from the first speaker 132a are both directed along a second direction that intersects within the first direction within the combined acoustic chamber 840. For example, the audio 950, 952 may be in phase with each other and may combine in the combined acoustic chamber 840 via a process of constructive interference. Accordingly, the combined audio may have a volume, gain, and/or energy that is greater than the same for either of the audio 950 or 952 individually. By way of another example, the audio 950 and 952 may be separate audio portions of the same audio output (e.g., separate monophonic sounds, such as a left channel and a right channel). In this example, the audio 950 and 952 may blend within the combine acoustic chamber 840 such that the combined audio formed from the audio 950 and 952 includes a more complete audio output (e.g., stereophonic sound).

With reference to FIGS. 9A-9B, the first audio device 102a may be coupled to the second audio device 102a, and both devices 102a, 102b may be placed on a surface of an object 902. In some embodiments, posterior sides of portions of the hooking body 302 and the device body 306 of the first audio device 102a and posterior sides of portions of the hooking body 802 and the device body 806 of the second audio device 102b may physically engage the surface of the object 902 while the devices 102a, 102b are resting on the surface. In some embodiments, the first audio device 102a and the second audio device 102b may rest on their respective battery charging ports 342, 842 (e.g., as illustrated in FIG. 8C) In the example illustrated in FIG. 9A, the surface of the object 902 is at least substantially flat.

In some embodiments, the speakers 132, 132a may output sound into the combined acoustic chamber 840. The combined acoustic chamber 840 may function as a front volume for the speakers 132, 132a, enabling the speakers 132, 132a to use the air in the combined acoustic chamber 840 to generate sound relatively efficiently. When the audio devices 102a, 102b are operating in a group-listening mode such that the speakers 132, 132a are configured to operate as low-range, group-listening speakers, low-frequency sounds generated from the speaker 132, 132a may be directed into the combined acoustic chamber 840, and the sound may exit into the ambient air via the combined acoustic opening 842 (e.g., in a direction indicated by dotted line 918). In some embodiments, the combined acoustic chamber 840, the combined acoustic opening 842, and (in some embodiments, e.g., as illustrated in FIGS. 9A-9B) the surface of the object 902 may function as an acoustic horn that collectively improve impedance matching, bass response, and power consumption of the speakers 132, 132a while also effectively directing sound away from the audio devices into the ambient air (e.g., in a directed indicated by dotted line 918). In some embodiments, the sound exiting the combined acoustic opening 842 may be reflected off the surface of the object 902 in a different direction (e.g., as indicated by dotted line 920 in FIG. 9B) from the direction in which the sound initially exits the combined acoustic opening 842. In such embodiments, the reflected sound may spread into the ambient air, increasing the perceived bass response of the sound. In some additional (or alternative) embodiments, the combined acoustic chamber 840 and combined acoustic opening 842 may function as a Helmholtz resonator, thereby enabling the speakers 132, 132a to generate low-frequency sounds effectively and with less power.

At the same time the speakers 132, 132a are generating low-frequency sounds, the speaker 134, 134a may be configured to generate synchronized, high-frequency sound that is directed away from the first audio device 102a and the second audio device 102b, respectively, via the opening 354 (e.g., in a direction indicated by dotted line 912a) and via the opening 854 (e.g., in a direction indicated by dotted line 912b).

In some embodiments (e.g., as illustrated in FIGS. 9A-9B), the first audio device 102a and second audio device 102b may make substantial physical contact with the surface of the object 902 via, respectively, the hooking body 302 and the device body 306 of the first audio device 102a and the hooking body 802 and the device body 806 of the second audio device 102b. As a result of this physical contact with the surface of the object 902, the low-frequency sounds generated by the speakers 132, 132a (e.g., while operating as low-range, group-listening speakers) may pass through the physical structure of the first audio device 102a and the second audio device 102b into the object 902. Accordingly, the speakers 132, 132a may cause the object 902 to begin resonating due to the vibrational energy entering the object 902 from the audio devices 102a, 102b (e.g., as illustrated by dotted lines 916). The object 902 may then cause air near the surface of the object 902 to begin vibrating, thereby creating additional low frequency sounds that travel into the ambient air (e.g., as indicate by dotted lines 914), thereby increasing the overall bass response of the audio devices 102a, 102b. In some optional embodiments (not shown), the audio devices 102a, 102b may be coupled to or resting on a base device (e.g., the base device 103), that is resting on the surface of the object 902. In such optional embodiments, the vibrational energy from the devices 102a, 102b may travel to the object 902 through the base device. The base device may be configured such that the base device is in greater contact with the object 902 than the extent to which the devices 102a, 102b would contact the surface of the object, and as a result, the base device may enable more vibrational energy to reach the object 902, thereby producing more resonance.

FIG. 10 is a flow diagram of an illustrative method 1000 for selectively activating a group-listening mode or a personal-listening mode on an audio device. In some embodiments, the method 1000 may be implemented by a speaker control service operating on an audio device (e.g., the speaker control service 166 operating on the first audio device 102a or the speaker control service 166a operating on the second audio device 102b, as described with reference to FIGS. 2 and 7).

The speaker control service 166 may begin performing the operations of the method 1000 by causing the first speaker 132 of the first audio device 102a to transition to an active state, in block 1002. In some embodiments of the operations performed in block 1002, the speaker control service 166 may cause the first speaker 132 to transition to a high-power state, for example, from a low-power or standby state.

In determination block 1004, the speaker control service 166 may determine whether to configure the first audio device to operate in a personal-listening mode. In some embodiments, the speaker control service 166 may determine whether a user input has been received that indicates a user's desire to activate the personal-listening mode (e.g., by receiving a command signal from a computing device in communication with the first audio device 102a as a result of the user's selection of a personal-listening mode option on the computing device). In some embodiments, the speaker control service 166 may determine to configure the first audio device 102a to operate in a personal-listening mode in response to determining that the first audio device 102a is decoupled from the second audio device 102b (e.g., as determine based on sensor readings from the sensors 150 indicating that the devices 102a, 102b are decoupled).

In response to determining to configure the first audio device 102a to operate in a personal-listening mode (i.e., determination block 1004=“YES”), the speaker control service 166 may cause the first speaker to operate as a full-range, personal-listening speaker, in block 1006. In some embodiments, the speaker control service 166 may perform the operations of block 1006 by causing the first speaker 132 to operate as a full-range, personal-listening speaker by causing one or more processing units on the first audio device 102a to send full-range audio signals to the first speaker 132 to output as full-range sound.

In some embodiments in which the first audio device 102a is in communication with the second audio device 102b and plays out audio in conjunction with the second audio device 102b (e.g., synchronized audio output), the speaker control service 166 may also cause the first speaker 132a of the second audio device 102b to operate as a full-range, personal-listening speaker, for example, by sending a signal to the speaker control service 166a operating on the second audio device 102b.

In optional block 1008, the speaker control service 166 may cause the second speaker 134 to transition to an inactive state, for example, in the event that the second speaker 134 was in an active state. Specifically, the speaker control service 166 may perform the operations in optional block 1008 in order to reduce the amount of power used by the second speaker 134, thereby prolonging battery life in some embodiments in which the first audio device 102a is battery powered.

In response to determining not to configure the first audio device 102a in a personal-listening mode (i.e., determination block 1004=“NO”) or after causing the first speaker to operate as a full-range, personal-listening speaker in block 1006, the speaker control service 166 may determine whether to configure the first audio device 102a to operate in a group-listening mode, in determination block 1010. In some embodiments, the speaker control service 166 may determine to configure the first audio device 102a to operate in a group-listening mode in response to receiving a signal from a computing device in connection with the first audio device 102a indicating that a user has selected an option enabling the group-listening mode. In some embodiments, the speaker control service 166 may determine to configure the first audio device 102a to operate in a group-listening mode in response to determining that the first audio device 102a is coupled to the second audio device 102b. In some embodiments, the speaker control service 166 may determine to configure the first audio device 102a to operate in a group-listening mode in response to determining that the first audio device 102a is coupled to the second audio device 102b and determining that a user selection of a group-listening mode has been made (e.g., via selection of a graphical user element—such as a virtual button—on a computing device in communication with the first audio device 102a).

In response to determining to configure the first audio device to operate in a group-listening mode (i.e., determination block 1010=“YES”), the speaker control service 166 may cause the first speaker 132 of the first audio device 102a to operate as a low-range, group-listening speaker. In some embodiments, the speaker control service 166 may cause one or more processing units to provide audio signals to the first speaker 132 that include audio frequencies in a low range (e.g., bass frequencies). In some embodiments, the speaker control service 166 may cause the first speaker 132a of the second audio device 102b to operate as a low-range, group-listening speaker by sending a signal to the speaker control service 166a of the second audio device 102b indicating as much.

In optional block 1014, the speaker control service 166 may cause the second speaker 134 of the first audio device 102a to transition to an active state, for example, in the event the second speaker 134 was operating in a lower-power or inactive state (e.g., as a result of the speaker control service 166's performing the operations of block 1008). In block 1016, the speaker control service 166 may cause the second speaker 134 to operate as a high-range, group-listening speaker. In some embodiments, the speaker control service 166 may cause one or more processing units to provide audio signals to the second speaker 134 that include high-range sound frequencies. The speaker control service 166 may cause the speaker control service 166a of the second audio device 102b to cause the second speaker 134a to operate as a high-range, group-listening speaker by sending the speaker control service 166a a signal indicating the same.

In response to determining not to configure the first audio device to operate in a group-listening mode (i.e., determination block 1010=“NO”) or after causing the second speaker to operate as a high-range, group-listening speaker in block 1016, the speaker control service 166 may determine whether to configure the first audio device to operate in a low-power mode, in determination block 1018. For example, the speaker control service 166 may determine whether a user input or user inactivity (as determined by a timer) indicate that the first audio device 102a should be put in a low-power or standby mode.

In response to determining not to configure the first audio device 102a in a low-power mode (i.e., determination block 1018=“NO”), the speaker control service 166 may repeat the operations performed above in a loop starting in determination block 1004. In response to determining to configure the first audio device 102a to operate in a low-power mode (i.e., determination block 1018=“YES”), the speaker control service 166 may cause the first speaker 132 and the second speaker 134 to transition from an active state to an inactive or standby state in block 1020. The speaker control service 166 may then cease performing the operations of the method 1000.

While the operations of the method 1000 are described above as being performed by the first audio device 102a (e.g., by the speaker control service 166 operating on the first audio device 102a), in some embodiments, the second audio device 102b, the base device 103, and/or another computing device in communication with the first audio device 102a and the second audio device 102b (e.g., the mobile computing device 106 as described with reference to FIG. 1) may perform one or more of the operations of the method 1000. For example, the computing device 106 may determine whether the first audio device 102a and the second audio device 102b are secured to the user in determination block 1004 and 1006 by requesting sensor information from the devices 102a, 102b (e.g., sensor information related to or determinations made by the devices 102a, 102b regarding whether those devices 102a, 102b are secured to the user). In another example, a speaker control service operating on the second audio device 102b may perform one or more of the above operations to determine whether to enable or cause to be enabled a group-listening mode and/or a personal-listening mode on the second audio device 102b and/or the first audio device 102a. In some embodiments, the speaker control service 166 and speaker control service 166a may each perform the above operations on the first audio device 102a and the second audio device 102b, respectively, in response to receiving one or more signal or commands from a computing device (e.g., the computing device 106) in communication with one or both of the first and second audio devices 102a, 102b.

In the above descriptions, audio devices are referred to as a “first” audio device and as a “second” audio device. Such references are merely for ease of reference and do not limit an audio device to being solely a “first” audio device or a “second” audio device. Similarly, in some embodiments, speakers are referred to as a “first” speaker and as a “second” speaker. Such references are merely for ease of reference and do not limit a speaker device to being solely a “first” speaker or a “second” speaker.

Although the terms group-listening speaker and group-listening mode are used herein, it is to be understood that such a group-listening speaker or group-listening mode is not necessarily limited to sound output functionality (or listening by a user). Rather, it is appreciated that “group-listening speaker” and “group-listening mode” may encompass use of the audio devices (and speakers thereof) described herein as a 2 way speaker phone with a suitable microphone for receiving sound from a user or group of users. Accordingly, a group-listening speaker and a group-listening mode may also be considered and/or referred to as a group-communication speaker and a group-communication mode, respectively.

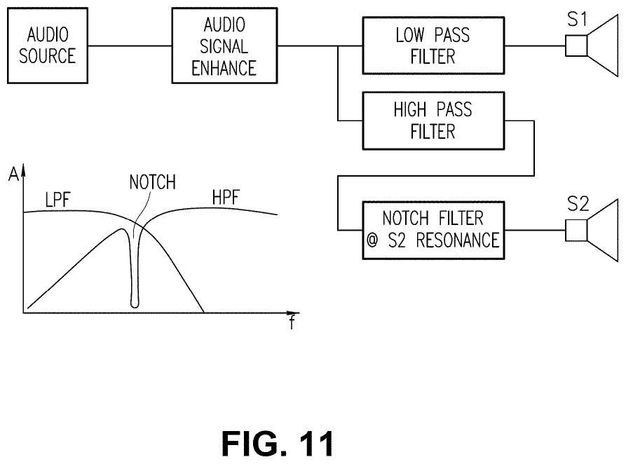

The audio systems and methods described herein may also utilize various electronic filter circuitry to minimize distortion and reduce power consumption. For example, in some implementations, the audio systems and methods may utilize a cross over filter in combination with a notch filter that is precisely matched to the resonance of one of the speakers (e.g., the second speaker, which may be a micro-speaker configured to efficiently generate high-range frequencies), as illustrated, for example, in FIG. 11. In other instances, other electronic filter circuitry may be used.

It is to be understood that not necessarily all objects or advantages may be achieved in accordance with any particular embodiment described herein. Thus, for example, those skilled in the art will recognize that certain embodiments may be configured to operate in a manner that achieves or optimizes one advantage or group of advantages as taught herein without necessarily achieving other objects or advantages as may be taught or suggested herein.

Conditional language such as, among others, “can,” “could,” “might” or “may,” unless specifically stated otherwise, are otherwise understood within the context as used in general to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B and C” can include a first processor configured to carry out recitation A working in conjunction with a second processor configured to carry out recitations B and C.

It should be emphasized that many variations and modifications may be made to the above-described embodiments, the elements of which are to be understood as being among other acceptable examples. All such modifications and variations are intended to be included herein within the scope of this disclosure and protected by the following claims.

1. An audio device, comprising:
a first speaker;
a second speaker;
a hooking body; and
a device body coupled to the hooking body,
wherein:
the first speaker is selectively configurable to operate as a low-range, group-listening speaker or a full-range, personal-listening speaker;
the second speaker is configured to operate as a high-range, group-listening speaker;
the first speaker and the second speaker are configured to operate together only while the first speaker and the second speaker operate as group-listening speakers.

2. The audio device of claim 1, wherein the first speaker is configured to produce sound frequencies substantially in the range of 20 Hz to 2000 Hz when operating as a low-range, group-listening speaker, the first speaker is configured to produce sound frequencies substantially in the range of 20 Hz to 20,000 Hz when operating as a full-range, personal-listening speaker, and the second speaker is configured to produce sound frequencies substantially in the range of 2000 Hz to 20,000 Hz while operating as a high-range, group-listening speaker.

3. The audio device of claim 1, wherein the first speaker is configured as at least one of a subwoofer or a woofer when operating as a low-range, group-listening speaker, and the second speaker is configured to as at least one of a mid-range tweeter or tweeter when operating as a high-range, group-listening speaker.

4. The audio device of claim 1, wherein, when the audio device is placed on a surface that is at least substantially flat, the device body and hooking body form an acoustic chamber near the first speaker and form an acoustic opening.

5. The audio device of claim 4, wherein the acoustic chamber and the acoustic opening are unformed when the audio device is removed from the surface.

6. The audio device of claim 4, wherein sound produced by the first speaker is directed through the acoustic chamber and exits the acoustic opening into ambient air.

7. The audio device of claim 6, wherein sound produced by the second speaker is not directed through the acoustic chamber.

8. The audio device of claim 4, wherein the acoustic chamber and the acoustic opening function as a Helmholtz resonator.

9. A first audio device, comprising:
a first speaker;
a second speaker;
a first hooking body; and
a first device body coupled to the first hooking body,
wherein:
the first hooking body is configured to couple to a second hooking body of a second audio device to form a combined acoustic chamber between the first audio device and the second audio device; and
the first speaker utilizes the combined acoustic chamber to generate low-range sound while the first hooking body is coupled to the second hooking body.

10. The first audio device of claim 9, wherein the first speaker is selectively configured as a personal-listening speaker and a group-listening device, and the second speaker is configured as a group-listening speaker.

11. The first audio device of claim 9, wherein a frontward side of the second speaker is configured to face the combined acoustic chamber.

12. The first audio device of claim 9, wherein:
the combined acoustic chamber encapsulates a front volume of air utilized by the first speaker to generate sound while the first speaker operates as a low-range, group-listening speaker; and
the first speaker is configured to output the sound in a direction towards the combined acoustic chamber.

13. The first audio device of claim 9, wherein, while the first hooking body is coupled to the second hooking body, the combined acoustic chamber is configured to at least one of direct, blend, or amplify the sound generated by the first speaker.

14. The first audio device of claim 9, wherein the combined acoustic chamber is configured to blend sound generated by the first speaker with sound generated by at least one speaker included in the second audio device, while the first hooking body is coupled to the second hooking body.

15. The first audio device of claim 9, wherein, when the first audio device is not coupled to the second audio device, the hooking body is configured to define a chamber suitable for accommodating a majority of an ear of a user.

16. The first audio device of claim 9, wherein the first hooking body comprises a first coupling device, and the first hooking body is configured to couple to the second hooking body when the first coupling device couples to a second coupling device included in the second hooking body.

17. The first audio device of claim 16, wherein the first coupling device is one of a magnet, an interlocking device, or a fastener.

18-24. (canceled)

25. A system, comprising:
a first audio device comprising a first speaker, a second speaker, a first hooking body, and a first device body coupled to the first hooking body;
a second audio device comprising a third speaker, a fourth speaker, a second hooking body, and a second device body coupled to the second hooking body; and
wherein:
the first hooking body and the second hooking body are configured to couple together to form an acoustic chamber and an acoustic opening between the first audio device and the second audio device; and
at least two of the first speaker, second speaker, third speaker, and fourth speaker utilize the combined acoustic chamber to generate sound.

26. The system of claim 25, wherein the acoustic chamber and the acoustic opening are unformed when the first audio device is decoupled from the second audio device.

27. The system of claim 25, wherein first sound produced by the first speaker and second sound produced by the third speaker are directed through the acoustic chamber and exit the acoustic opening into ambient air.

28-46. (canceled)
